(19) United States
(12) Patent Application Publication
(10) Pub. No.: US 2026/0095073 A1
(43) Pub. Date: Apr. 2, 2026

(54) ROTARY ELECTRIC MACHINE

(71) Applicant: Mitsubishi Electric Mobility Corporation, Tokyo (JP)

(72) Inventors: Takayuki IIDA, Tokyo (JP); Masatsugu NAKANO, Tokyo (JP); Hitoshi ISODA, Tokyo (JP); Junji KITAO, Tokyo (JP); Takeshi KUBOTA, Tokyo (JP)

(73) Assignee: Mitsubishi Electric Mobility Corporation, Tokyo (JP)

(21) Appl. No.: 19/113,480

(22) PCT Filed: Nov. 16, 2022
(86) PCT No.: PCT/JP2022/042475

§ 371 Date: Mar. 20, 2025

(51) Int. Cl. H02K 1/16

(52) U.S. Cl. CPC H02K 1/16; H02K 2213/03

(57) ABSTRACT

A rotary electric machine includes: a stator including a stator core composed of a plurality of divisional cores divided in a circumferential direction and combined in an annular shape, and a coil wound in a distributed manner on the stator core; and a rotor including a rotor core provided with magnetic poles of which a number of pole pairs is P, the rotor being rotatable relative to the stator. Each divisional core has a core back, a plurality of teeth protruding in a radially inward direction from the core back, and winding slots, and the divisional cores have equal numbers of teeth. Where a division number of the divisional cores is N, P<N<2P is satisfied.

### TECHNICAL FIELD

The present disclosure relates to a rotary electric machine.

### BACKGROUND ART

In order to reduce the material cost for a motor, a stator core which is formed by combining divisional cores divided in the circumferential direction and enables improvement in the yield of electromagnetic steel sheets, is widely used. When the stator core is divided into many pieces in the circumferential direction, the yield of electromagnetic steel sheets is more improved. Therefore, from the standpoint of material cost reduction, it is desirable that the division number of the stator core is great. However, if divisional cores of which the division number is great is employed, the number of components increases, so that the manufacturing cost increases, resulting in increase in assembly difficulty. Accordingly, a motor having divisional cores of which the division number is small is considered.

A motor having divisional cores obtained by common punching from an extra area inside a rotor so as to reduce the material cost is disclosed (for example, Patent Document 1).

### CITATION LIST

### Patent Document

Patent Document 1: Japanese Laid-Open Patent Publication No. 2002-186227

### SUMMARY OF THE INVENTION

### Problem to be Solved by the Invention

Meanwhile, when a magnetomotive force and a permeance contain the same harmonic components, shaft voltage occurs at a shaft of a rotor. In an actual motor, when divisional cores are combined, it is difficult to prevent formation of a slight gap between the divisional cores, and due to the gap, a permeance harmonic is caused, so that shaft voltage occurs.

In a case where the rotor of the motor is supported by a mechanical bearing, discharge occurs between the shaft and the bearing due to shaft voltage and this causes electrolytic corrosion of the bearing, resulting in vibration and noise. Therefore, designing for reducing the shaft voltage is needed.

Accordingly, in a motor using divisional cores, it is important to consider a combination of the number of poles of a rotor and a division number of a stator. In addition, a combination of the number of poles of the rotor and the division number of the stator where shaft voltage does not occur even if there is a gap between the divisional cores is such a combination that the division number is an integer multiple of the number of poles, but in this case, torque ripple might increase.

Patent Document 1 has no description about shaft voltage and torque ripple, and the disclosed example has a problem that shaft voltage occurs due to a gap between the divisional cores and that torque ripple increases even though shaft voltage does not occur.

The present disclosure has been made to solve the above problem, and an object of the present disclosure is to provide a rotary electric machine for which the material cost is reduced and manufacturing is facilitated and in which shaft voltage is reduced and torque ripple is suppressed.

### Means to Solve the Problem

A rotary electric machine according to the present disclosure includes a stator including a stator core composed of a plurality of divisional cores divided in a circumferential direction and combined in an annular shape, and a coil wound in a distributed manner on the stator core; and a rotor including a rotor core fixed to a shaft present at a center axis of the stator, the rotor core being provided with magnetic poles of which a number of pole pairs is P, the rotor being rotatable relative to the stator. Each divisional core has an arc-shaped core back and a plurality of teeth protruding in a radially inward direction from the core back, and has winding slots between the teeth, and the divisional cores have equal numbers of the teeth. Where a division number of the divisional cores is N, P<N<2P is satisfied.

A rotary electric machine according to the present disclosure includes a stator including a stator core composed of a plurality of divisional cores divided in a circumferential direction and combined in an annular shape, and a coil wound in a distributed manner on the stator core; and a rotor including a rotor core fixed to a shaft present at a center axis of the stator, the rotor core being provided with magnetic poles of which a number of pole pairs is P, the rotor being rotatable relative to the stator. Each divisional core has an arc-shaped core back and a plurality of teeth protruding in a radially inward direction from the core back, and has winding slots between the teeth, and the divisional cores have equal numbers of the teeth. Where a division number of the divisional cores is N, 2P<N<4P is satisfied.

### Effect of the Invention

The rotary electric machine according to the present disclosure makes it possible to obtain a rotary electric machine for which the material cost is reduced and manufacturing is facilitated and in which shaft voltage is reduced and torque ripple is suppressed.

### BRIEF DESCRIPTION OF THE DRAWINGS

FIG. 1 is a sectional view of a 6-division double-V-shaped interior-magnet-type motor with eight poles and forty-eight slots, in a rotary electric machine according to embodiment 1.

FIG. 2 is a sectional view of a divisional core composing a stator core of the rotary electric machine according to embodiment 1.

FIG. 3 is a perspective view of the stator core of the rotary electric machine according to embodiment 1.

FIG. 4 shows analysis data of a shaft voltage maximum value with the division number of the stator core as a parameter, in the rotary electric machine according to embodiment 1.

FIG. 5 shows analysis data of a torque ripple amplitude with the division number of the stator core as a parameter, in the rotary electric machine according to embodiment 1.

FIG. 6 is a sectional view of a 12-division double-V-shaped interior-magnet-type motor with eight poles and forty-eight slots, in a modification of the rotary electric machine according to embodiment 1.

FIG. 7 is a sectional view of a 6-division double-V-shaped interior-magnet-type motor with eight poles and seventy-two slots, in a modification of the rotary electric machine according to embodiment 1. FIG. 8 is a sectional view of a 12-division double-V-shaped interior-magnet-type motor with eight poles and ninety-six slots, in a modification of the rotary electric machine according to embodiment 1.

FIG. 9 is a sectional view of an 8-division double-V-shaped interior-magnet-type motor with twelve poles and seventy-two slots, in a modification of the rotary electric machine according to embodiment 1.

FIG. 10 is a sectional view of a 24-division double-V-shaped interior-magnet-type motor with sixteen poles and ninety-six slots, in a modification of the rotary electric machine according to embodiment 1.

FIG. 11 is a sectional view of a 6-division interior-flat-plate-magnet-type motor with eight poles and forty-eight slots, in a modification of the rotary electric machine according to embodiment 1.

FIG. 12 is a sectional view of a 12-division single-V-shaped interior-magnet-type motor with eight poles and forty-eight slots, in a modification of the rotary electric machine according to embodiment 1.

FIG. 13 is a sectional view of a 6-division triple-V-shaped interior-magnet-type motor with eight poles and forty-eight slots, in a modification of the rotary electric machine according to embodiment 1.

FIG. 14 is a sectional view of a 12-division reverse-triangular-shaped interior-magnet-type motor with eight poles and forty-eight slots, in a modification of the rotary electric machine according to embodiment 1.

FIG. 15 is a sectional view of a divisional core composing a stator core of a rotary electric machine according to embodiment 2.

FIG. 16 is a sectional view of a 6-division double-V-shaped interior-magnet-type motor with eight poles and forty-eight slots, in the rotary electric machine according to embodiment 2.

FIG. 17 is a perspective view of a stator core rotationally stacked in four stages with 30-degree rotation, in a rotary electric machine according to embodiment 3.

FIG. 18 illustrates a rolling direction and a tooth direction in a sectional view of a divisional core of a rotary electric machine according to embodiment 4.

FIG. 19 illustrates tooth numbers in the sectional view of the divisional core of the rotary electric machine according to embodiment 4. FIG. 20 illustrates tooth-direction components of rolling-direction magnetic characteristics of teeth at the same circumferential-direction position in respective segments of a stator core in a comparative example of the rotary electric machine according to embodiment 4.

FIG. 21 is a perspective view of a stator core of the rotary electric machine according to embodiment 4.

FIG. 22 illustrates tooth-direction components of rolling-direction magnetic characteristics of teeth at the same circumferential-direction positions in respective segments of the stator core of the rotary electric machine according to embodiment 4.

FIG. 23 is a sectional view of a divisional core composing a stator core of a rotary electric machine according to embodiment 5.

FIG. 24 is a sectional view of a 6-division double-V-shaped interior-magnet-type motor with eight poles and forty-eight slots, in the rotary electric machine according to embodiment 5 with the stator core divided at tooth centers.

FIG. 25 is a perspective view of the stator core rotationally stacked in six stages with 30-degree rotation, in the rotary electric machine according to embodiment 5.

FIG. 26 is a sectional view of a 12-division double-V-shaped interior-magnet-type motor with eight poles and forty-eight slots, in a modification of the rotary electric machine according to embodiment 5 with division at tooth centers.

FIG. 27 is a sectional view of a divisional core composing a stator core of a rotary electric machine according to embodiment 6.

FIG. 28 is a sectional view of a 4-division double-V-shaped interior-magnet-type motor with six poles and fifty-four slots, in the rotary electric machine according to embodiment 6 using core back division and tooth division.

FIG. 29 is a perspective view of a stator core rotationally stacked in two stages with 45-degree rotation in the rotary electric machine according to embodiment 6.

### DESCRIPTION OF EMBODIMENTS

### Embodiment 1

Embodiment 1 relates to a rotary electric machine including a stator including a stator core composed of a plurality of divisional cores divided in a circumferential direction and combined in an annular shape, and a coil wound in a distributed manner on the stator core; and a rotor including a rotor core fixed to a shaft present at a center axis of the stator, the rotor core being provided with magnetic poles of which a number of pole pairs is P, the rotor being rotatable relative to the stator. Each divisional core has an arc-shaped core back and a plurality of teeth protruding in a radially inward direction from the core back, and has winding slots between the teeth, and the divisional cores have equal numbers of the teeth. Where a division number of the divisional cores is N, P<N<2P or 2P<N<4P is satisfied.

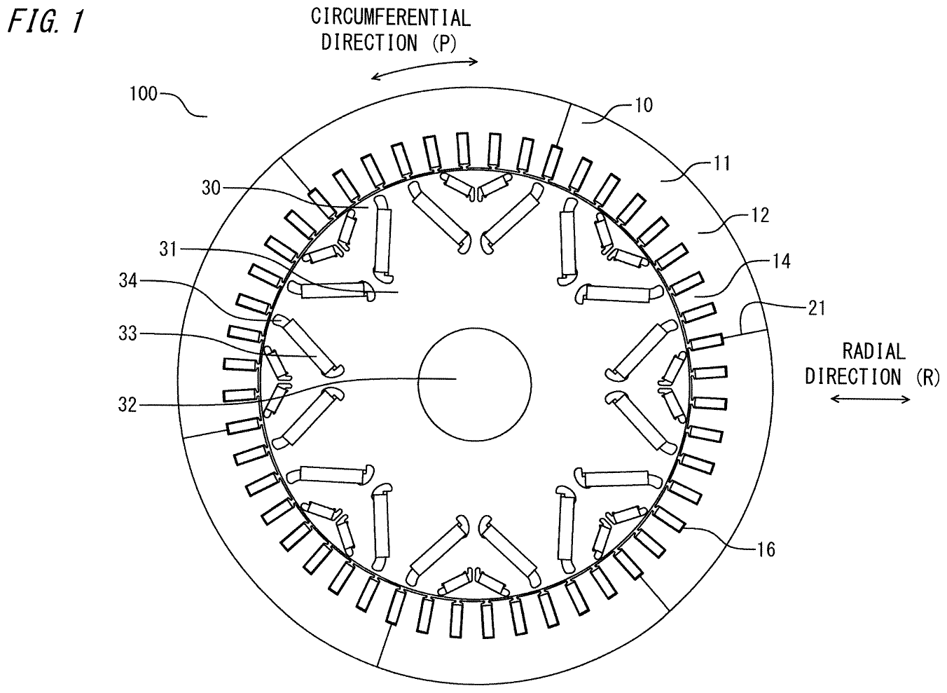

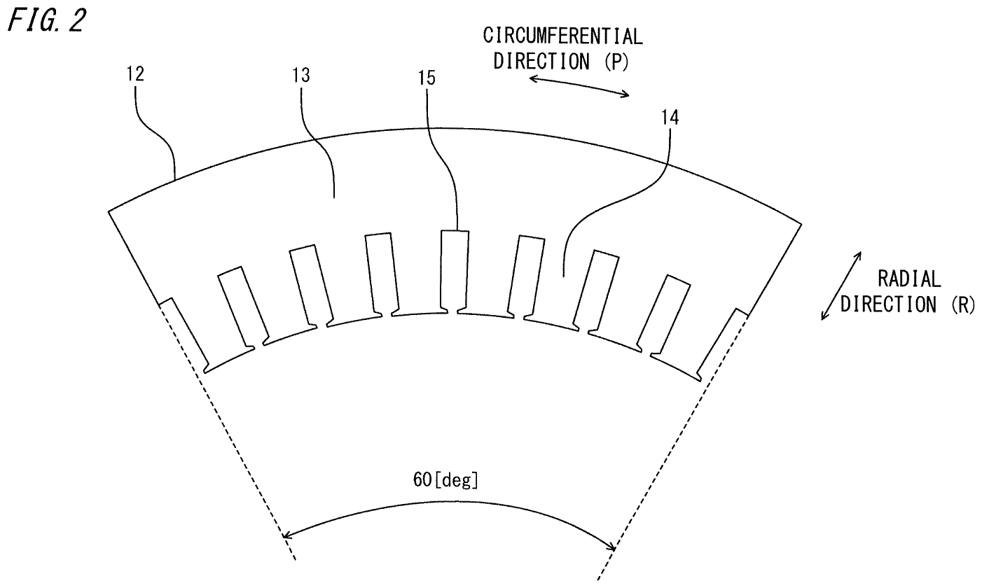

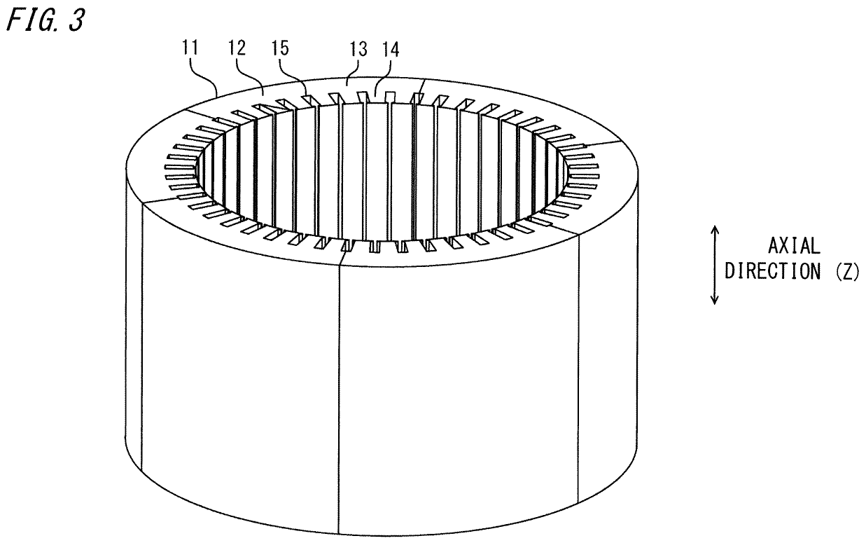

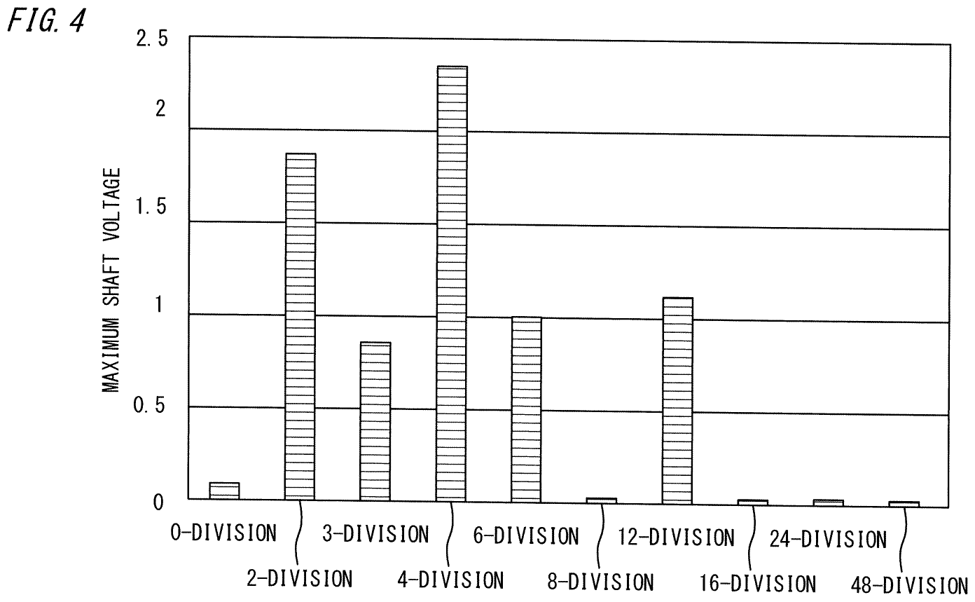

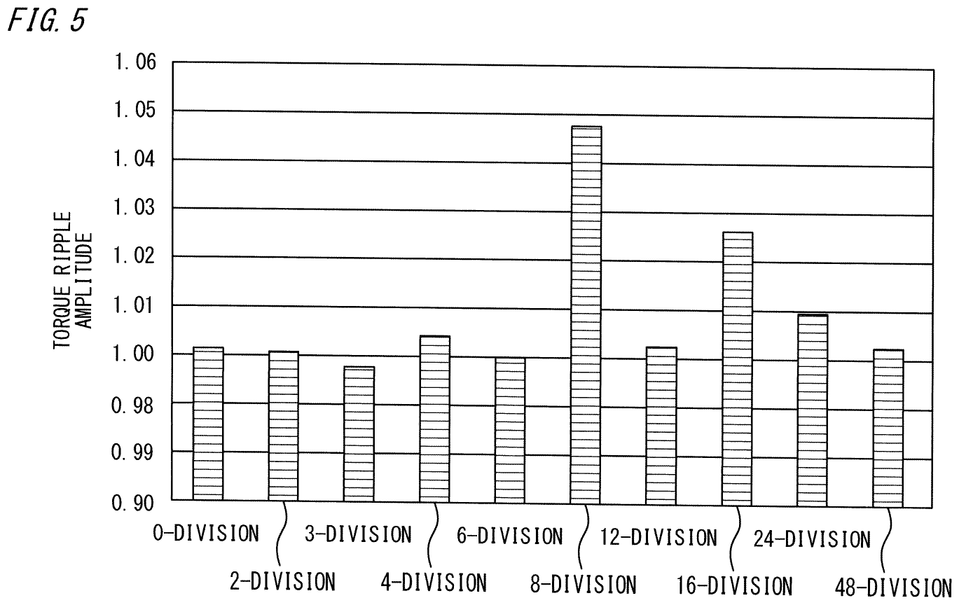

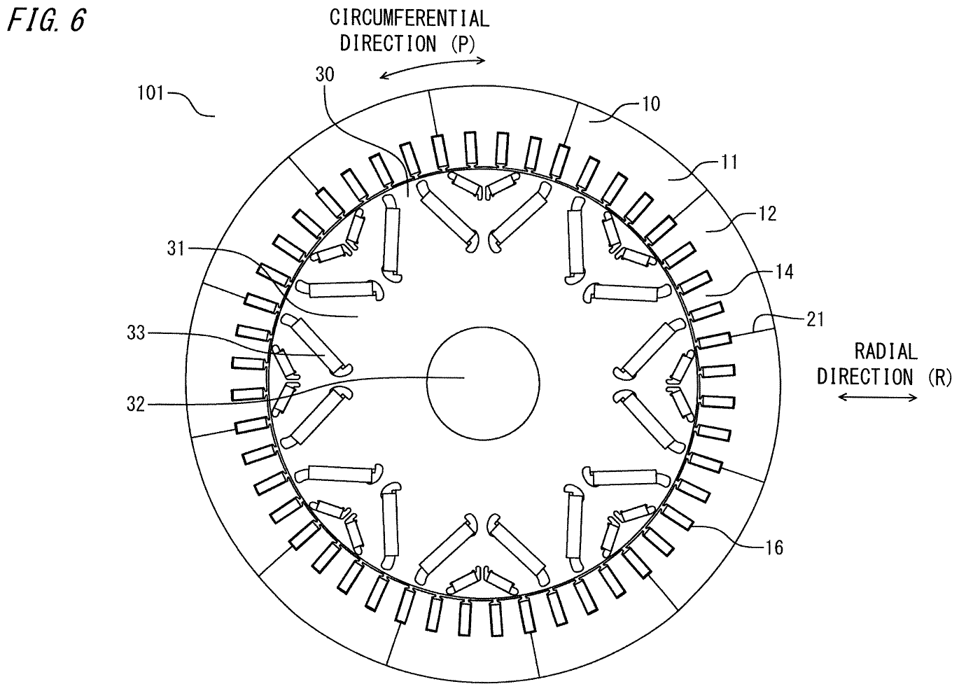

Hereinafter, the rotary electric machine according to embodiment 1 will be described with reference to FIG. 1 which is a sectional view of a 6-division double-V-shaped interior-magnet-type distribution-winding motor with eight poles and forty-eight slots, FIG. 2 which is a sectional view of a divisional core composing a stator core, FIG. 3 which is a perspective view of the stator core, FIG. 4 which shows analysis data of a shaft voltage maximum value with the division number of the stator core as a parameter, FIG. 5 which shows analysis data of a torque ripple amplitude with the division number of the stator core as a parameter, and FIG. 6 to FIG. 14 which are sectional views of interior-magnet-type distributed-winding motors in modifications of the rotary electric machine.

In the drawings, the same or corresponding parts denote the same reference characters, and the same description will not be repeated.

In the following description, a rotation-axis direction is defined as an axial direction (Z), a rotation-axis-center direction (a direction toward the rotation-axis center from the outer circumference of the stator) is defined as a radial direction (R), and a direction along a rotational direction about the rotation axis is defined as a circumferential direction (P), and these directions are written in some of the drawings.

In the present disclosure, the rotary electric machine is assumed to be an interior-magnet-type distributed-winding motor. Therefore, in the description, the interior-magnet-type distributed-winding motor may be referred to as an interior-magnet-type motor.

First, the entire structure of a rotary electric machine 100 of embodiment 1 will be described with reference to FIG. 1 which is a sectional view of the rotary electric machine 100 along a plane perpendicular to the axial direction, FIG. 2 which is a sectional view of the divisional core composing the stator core, and FIG. 3 which is a perspective view of the stator core.

The rotary electric machine 100 is composed of a stator 10, and a rotor 30 which is provided coaxially on the inner circumferential side of the stator 10 and is rotatable relative to the stator 10.

The stator 10 includes a stator core 11, teeth 14, and a coil 16. The stator core 11 is composed of divisional cores 12 of which a division number described later is N (in FIG. 1, the division number N is 6), and includes a core back 13, teeth 14, and winding slots 15.

The rotor 30 includes a rotor core 31, a shaft 32, and permanent magnets 33.

First, the divisional core 12 as a basic component of the stator 10 will be described with reference to FIG. 2.

The divisional core 12 composing the stator core 11 of the rotary electric machine 100 according to embodiment 1 is formed by stacking a plurality of electromagnetic steel sheets, and includes a plurality of teeth 14 protruding in the radially inward direction from the arc-shaped core back 13 toward the center axis, and winding slots 15 which are areas between the adjacent teeth 14. The divisional cores 12 are divided across the core backs 13 from the circumferential-direction centers of the winding slots 15 (core back division). Eight teeth 14 are arranged in the circumferential direction, and the arc angle of the divisional core 12 is 60 degrees.

Returning to FIG. 1, the rotary electric machine 100 will be described.

The stator core 11 is formed by arranging six divisional cores 12 described with reference to FIG. 2 in an annular shape, and the divisional cores 12 have equal numbers of teeth 14. Forty-eight teeth 14 are uniformly arranged in the circumferential direction. In the stator core 11 in embodiment 1, a slight gap 21 is formed between the divisional cores 12 at abutting parts formed between the divisional cores 12 arranged adjacently to each other.

In the stator core 11 in embodiment 1, such gaps 21 are formed at most of the abutting parts between the divisional cores 12, depending on manufacturing variations. The widths and the sizes of the gaps 21 are different among the abutting parts between the divisional cores 12.

The coil 16 is stored in each winding slot 15. Each coil 16 is connected in series to the coil 16 stored in the winding slot 15 that is six-slot away in the circumferential direction.

The rotor 30 includes the shaft 32 present at the center axis of the stator 10, the annular rotor core 31 fixed to the shaft 32, and the permanent magnets 33 arranged in two layers in V shapes in magnet slots 34 provided in the rotor core 31 so as to form eight magnetic poles (double-V-shaped interior-magnet type).

As shown in FIG. 3, the stator core 11 is formed such that division positions are the same among all cross-sections as seen in the axial direction. Thus, a distributed-winding motor with eight poles and forty-eight slots using six divisional cores is formed.

Next, shaft voltage and torque ripple that occur in a rotary electric machine, and a method for suppressing them, will be described using electromagnetic field analysis results shown in FIG. 4 and FIG. 5.

FIG. 4 shows a result of analysis on the maximum value of shaft voltage in a case where the stator core 11 is equally divided (0-division, 2-division, 3-division, 4-division, 6-division, 8-division, 12-division, 16-division, 24-division, 48-division) across the core backs 13 and the gaps 21 of 25 μm are formed between the divisional cores 12, in the distributed-winding motor with eight poles and forty-eight slots. Here, shaft voltage maximum values are normalized with a shaft voltage maximum value in a case of 6-division.

FIG. 5 shows a result of analysis on a torque ripple amplitude in a case where the stator core 11 is equally divided (0-division, 2-division, 3-division, 4-division, 6-division, 8-division, 12-division, 16-division, 24-division, 48-division) across the core backs 13 and the gaps 21 of 25 μm are formed between the divisional cores 12, in the distributed-winding motor with eight poles and forty-eight slots. Here, torque ripple amplitudes are normalized with a torque ripple amplitude in a case of 6-division.

It is known that the shaft voltage which is one of the problems to be solved by the present disclosure occurs when the same components are present in the magnetomotive force harmonics and the permeance harmonics. In the motor in which the divisional cores 12 divided in the circumferential direction are used for the stator core 11, a slight gap 21 is formed between the adjacent divisional cores, and this causes a permeance harmonic.

In the interior-magnet-type motor with eight poles and forty-eight slots, when the gaps 21 are formed between the divisional cores 12, shaft voltage occurs in cases of 2-division, 3-division, 4-division, 6-division, and 12-division. In 2-division and 4-division, permeance harmonics that are the same components as all the magnetomotive force harmonics are present, and therefore it is expected that the shaft voltage increases.

As shown in FIG. 4, shaft voltage occurs in cases of 2-division, 3-division, 4-division, 6-division, and 12-division, and in particular, in 2-division and 4-division, permeance harmonics that are the same components as all the magnetomotive force harmonics are present, and thus it has been confirmed that shaft voltage increases.

When the stator core 11 is divided by a number that is an integer multiple of the number of poles, shaft voltage does not occur. However, in a case where the divisional cores 12 of which the number is an integer multiple of the number of poles are used and the gap 21 is formed between the divisional cores 12, torque ripple might increase.

As shown in FIG. 5, in an 8-division interior-magnet-type motor, it is found that torque ripple increases by as much as about 5% as compared to a 6-division interior-magnet-type motor which is the rotary electric machine 100 of embodiment 1. Also in interior-magnet-type motors for 16-division, 24-division, and 48-division corresponding to integer multiples of the number of poles, torque ripple increases as compared to a 6-division interior-magnet-type motor.

According to the above results, in the interior-magnet-type motor with eight poles and forty-eight slots, division numbers that are determined to be appropriate in consideration of both of low shaft voltage and low torque ripple are 3, 6, and 12.

The effect of material cost reduction for the divisional core 12 can be sufficiently provided by the 6-division motor of embodiment 1 of which the division number is greater than a number P of pole pairs, and a 12-division motor shown in FIG. 6 described later. These division numbers satisfy a relationship of P<N<2P (condition A) or 2P<N<4P (condition B).

As described above, in embodiment 1, the divisional cores 12 of the rotary electric machine 100 are configured, whereby the yield of electromagnetic steel sheets for the divisional cores 12 improves, so that the material cost can be reduced. Further, by using the divisional cores 12 of which the division number is small, the number of components can be reduced and manufacturing can be facilitated.

In addition, the relationship between the number of pole pairs and the division number satisfies P<N<2P (condition A) or 2P<N<4P (condition B), whereby shaft voltage occurring depending on a combination of the number of poles and the division number of the stator core 11 can be reduced and torque ripple occurring depending on the number of poles and the division number of the stator core 11 can also be suppressed.

In addition, by the core back division structure, strain of the teeth 14 is suppressed, whereby manufacturing strain in the entire interior-magnet-type motor is reduced, so that motor loss can be reduced.

Here, the relationship between the division number N of the divisional cores 12 and a number S of the winding slots 15 will be described.

When the circumferential-direction division number N of the stator core 11 is a divisor of S, all the shapes of the divisional cores 12 composing the stator core 11 can be made the same. Thus, the manufacturing cost for the divisional cores 12 can be reduced.

Next, modifications of the 6-equal-division double-V-shaped interior-magnet-type distributed-winding motor with eight poles and forty-eight slots described in embodiment 1 will be described together with the relationships of P<N<2P (condition A) and 2P<N<4P (condition B).

In the drawings, each rotary electric machine is denoted by 101, etc., for the purpose of discrimination from the rotary electric machine (6-equal-division double-V-shaped interior-magnet-type distributed-winding motor with eight poles and forty-eight slots) 100 shown in FIG. 2.

FIG. 6 is a sectional view of a double-V-shaped interior-magnet-type distributed-winding motor (rotary electric machine 101) with eight poles and forty-eight slots where the stator core 11 is equally divided into twelve pieces in the circumferential direction across the core backs 13. In this example, 2P<N<4P (condition B) is satisfied.

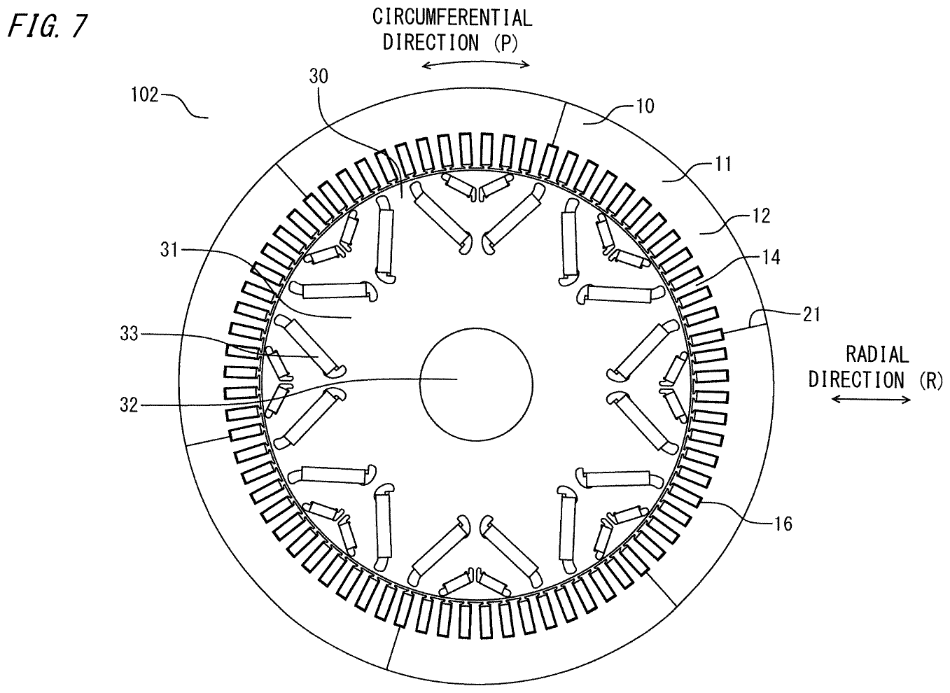

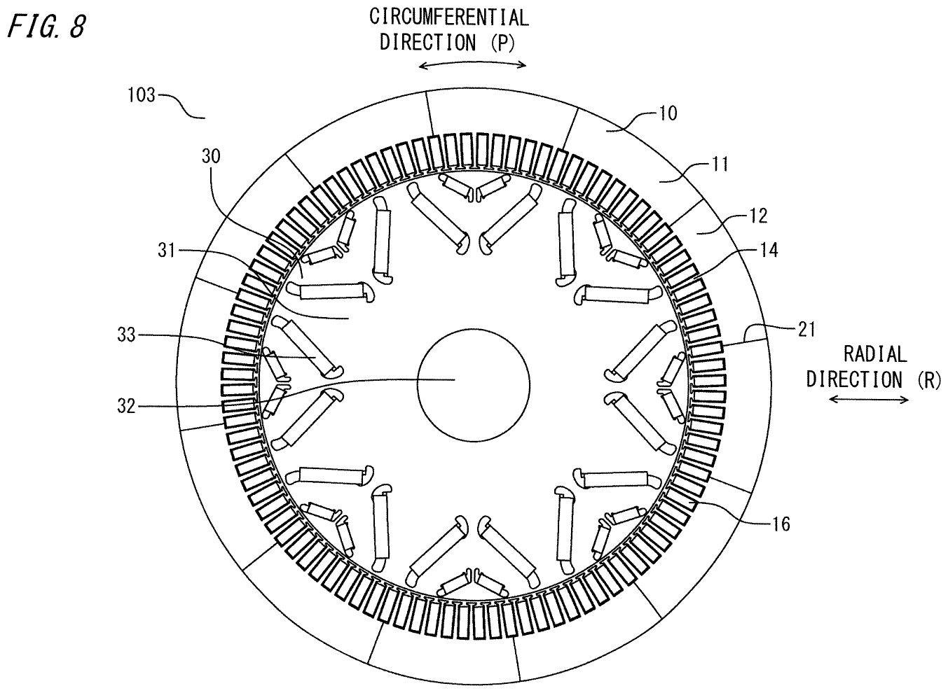

FIG. 7 is a sectional view of a double-V-shaped interior-magnet-type distributed-winding motor (rotary electric machine 102) with eight poles and seventy-two slots where the stator core 11 is equally divided into 6 pieces in the circumferential direction across the core backs 13. In this example, P<N<2P (condition A) is satisfied.

FIG. 8 is a sectional view of a double-V-shaped interior-magnet-type distributed-winding motor (rotary electric machine 103) with eight poles and ninety-six slots where the stator core 11 is equally divided into twelve pieces in the circumferential direction across the core backs 13. In this example, 2P<N<4P (condition B) is satisfied.

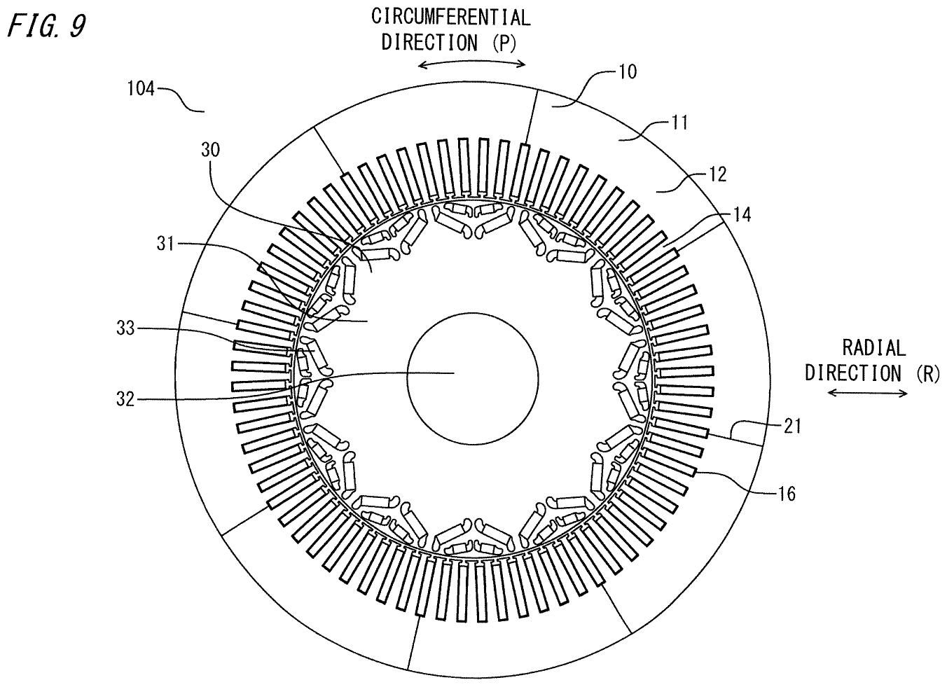

FIG. 9 is a sectional view of a double-V-shaped interior-magnet-type distributed-winding motor (rotary electric machine 104) with twelve poles and seventy-two slots where the stator core 11 is equally divided into eight pieces in the circumferential direction across the core backs 13. In this example, P<N<2P (condition A) is satisfied.

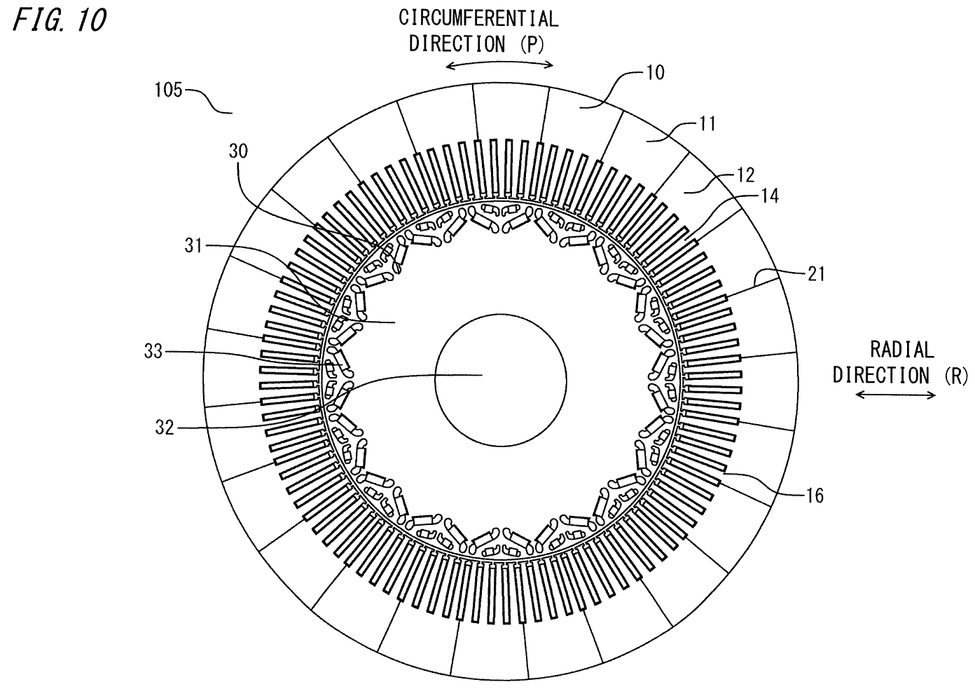

FIG. 10 is a sectional view of a double-V-shaped interior-magnet-type distributed-winding motor (rotary electric machine 105) with sixteen poles and ninety-six slots where the stator core 11 is equally divided into twenty-four pieces in the circumferential direction across the core backs 13. In this example, 2P<N<4P (condition B) is satisfied.

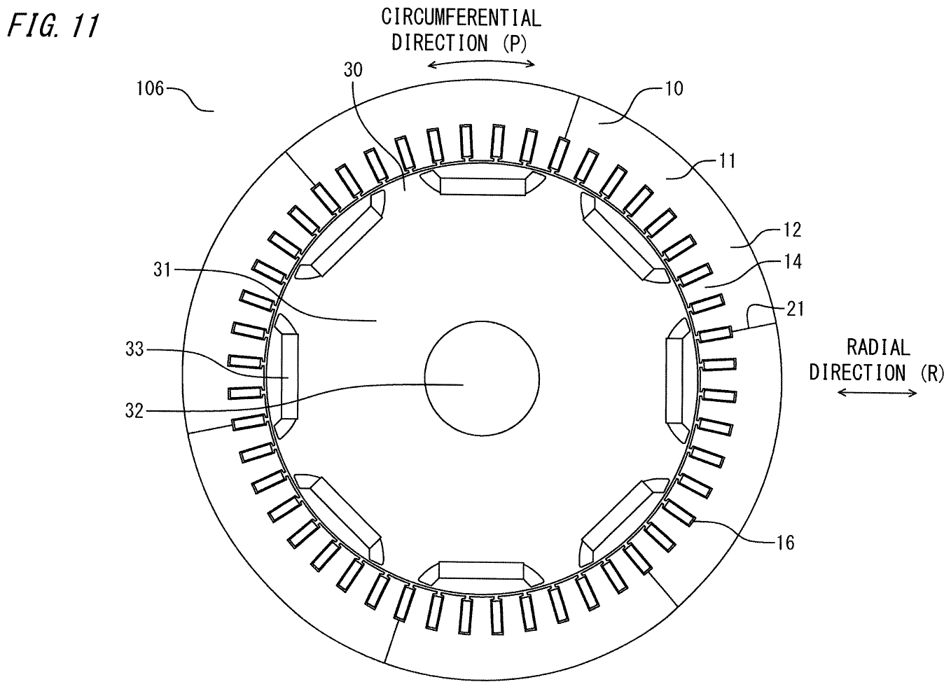

FIG. 11 is a sectional view of an interior-flat-plate-magnet-type distributed-winding motor (rotary electric machine 106) with eight poles and forty-eight slots where the stator core 11 is equally divided into six pieces in the circumferential direction across the core backs 13. In this example, P<N<2P (condition A) is satisfied.

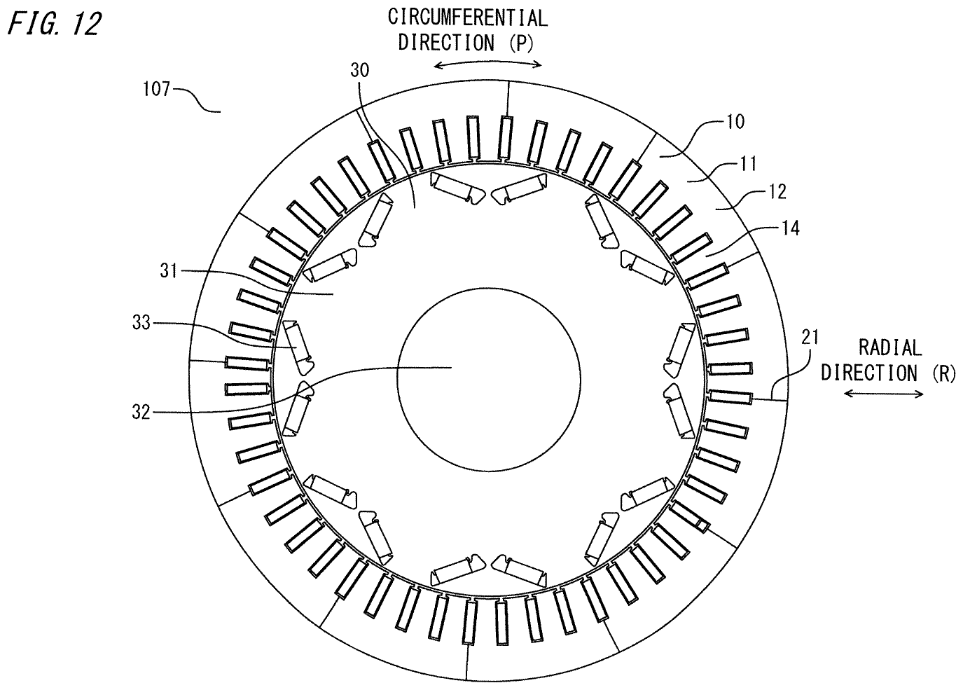

FIG. 12 is a sectional view of a single-V-shaped interior-magnet-type distributed-winding motor (rotary electric machine 107) with eight poles and forty-eight slots where the stator core 11 is equally divided into twelve pieces in the circumferential direction across the core backs 13. In this example, 2P<N<4P (condition B) is satisfied.

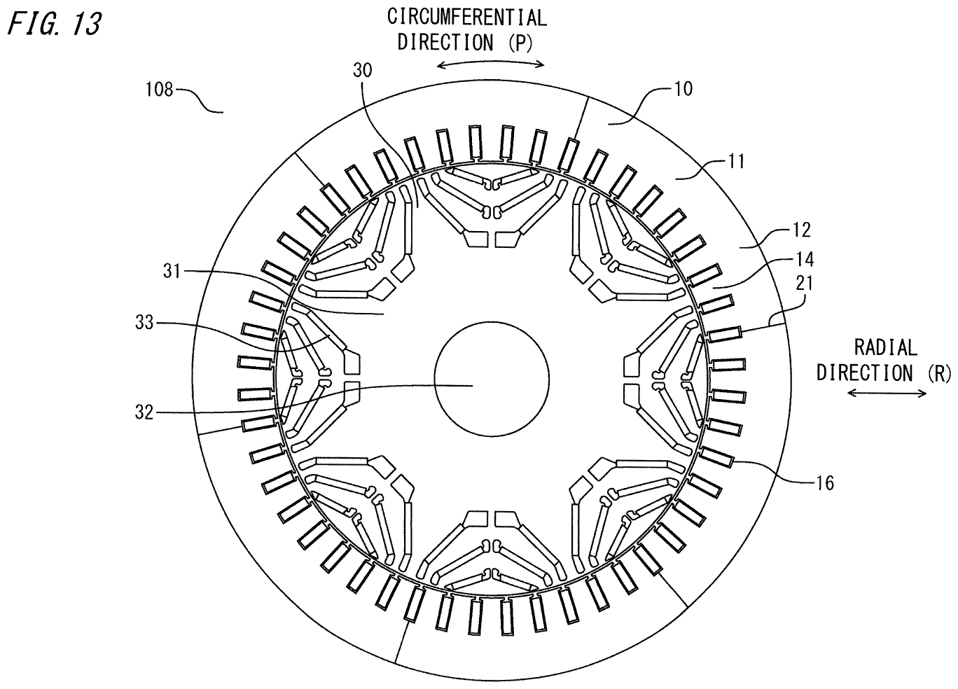

FIG. 13 is a sectional view of a triple-V-shaped interior-magnet-type distributed-winding motor (rotary electric machine 108) with eight poles and forty-eight slots where the stator core 11 is equally divided into six pieces in the circumferential direction across the core backs 13. In this example, P<N<2P (condition A) is satisfied.

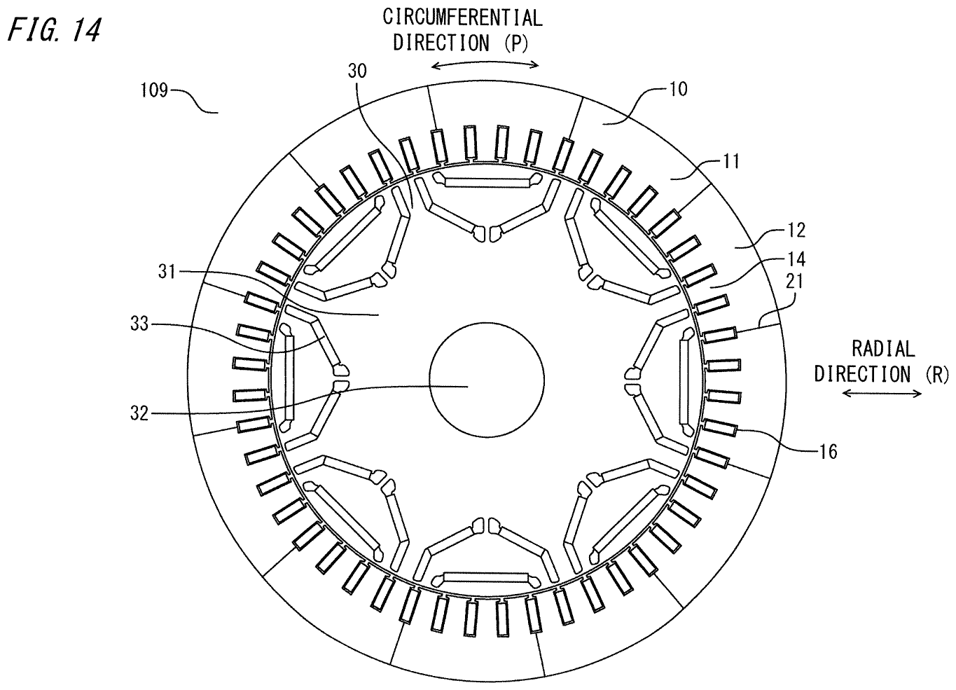

FIG. 14 is a sectional view of a reverse-triangular-shaped interior-magnet-type distributed-winding motor (rotary electric machine 109) with eight poles and forty-eight slots where the stator core 11 is equally divided into twelve pieces in the circumferential direction across the core backs 13. In this example, 2P<N<4P (condition B) is satisfied.

Here, the interior-magnet-type distributed-winding motors in the modifications shown in FIG. 6 to FIG. 14 are summarized.

The distributed-winding motor with eight poles and forty-eight slots using twelve divisional cores in FIG. 6 satisfies 2P<N<4P (condition B) and provides the same effects as the rotary electric machine of embodiment 1.

Even in the cases of having different combinations of the number of pole pairs and the number of slots as shown in FIG. 7 to FIG. 10, if the relationship between the number of pole pairs and the division number satisfies P<N<2P (condition A) or 2P<N<4P (condition B), the same effects are provided.

Even in different interior-magnet-type rotor structures as shown in FIG. 11 to FIG. 14, if the relationship between the number of pole pairs and the division number satisfies P<N<2P (condition A) or 2P<N<4P (condition B), the same effects as in the rotary electric machine of embodiment 1 are provided.

Further, although not shown, also in a surface-bonded type and a winding field structure, if the relationship between the number of pole pairs and the division number satisfies P<N<2P (condition A) or 2P<N<4P (condition B), the same effects as in the rotary electric machine of embodiment 1 can be obtained.

In a case where the gaps 21 formed at the abutting parts between the adjacent divisional cores 12 described as the configuration of the stator core 11 in embodiment 1 are different in widths and sizes, if the division number is set to be small while satisfying P<N<2P (condition A), permeance harmonics occurring due to variations in the gaps 21 can be reduced, whereby shaft voltage can be reduced more effectively.

As described above, the rotary electric machine of embodiment 1 includes a stator including a stator core composed of a plurality of divisional cores divided in a circumferential direction and combined in an annular shape, and a coil wound in a distributed manner on the stator core; and a rotor including a rotor core fixed to a shaft present at a center axis of the stator, the rotor core being provided with magnetic poles of which a number of pole pairs is P, the rotor being rotatable relative to the stator. Each divisional core has an arc-shaped core back and a plurality of teeth protruding in a radially inward direction from the core back, and has winding slots between the teeth, and the divisional cores have equal numbers of the teeth. Where a division number of the divisional cores is N, P<N<2P or 2P<N<4P is satisfied.

Thus, embodiment 1 provides a rotary electric machine for which the material cost is reduced and manufacturing is facilitated and in which shaft voltage is reduced and torque ripple is suppressed.

### Embodiment 2

In embodiment 2, a projection and a recess for fitting are provided at abutting parts of the divisional cores, and a groove is provided on an outer circumferential portion.

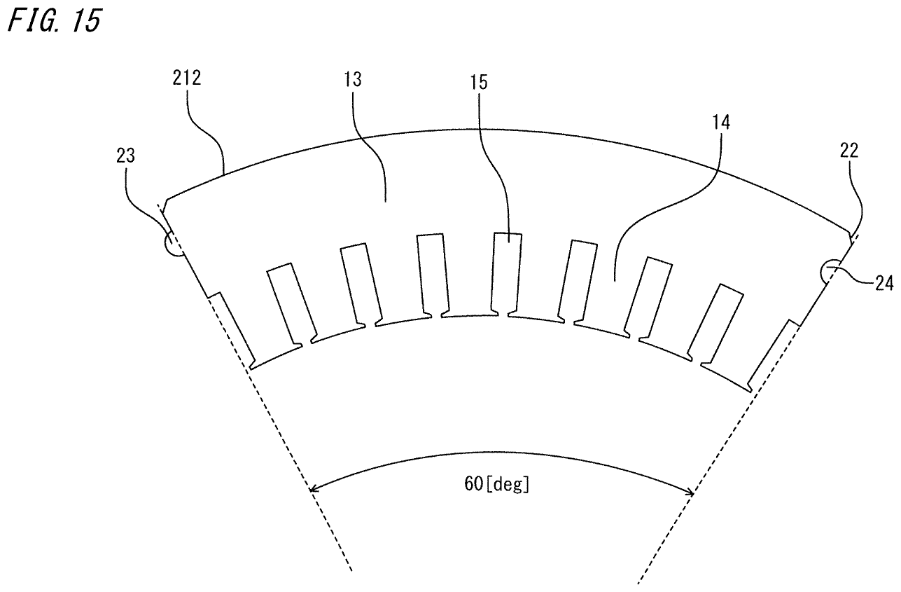

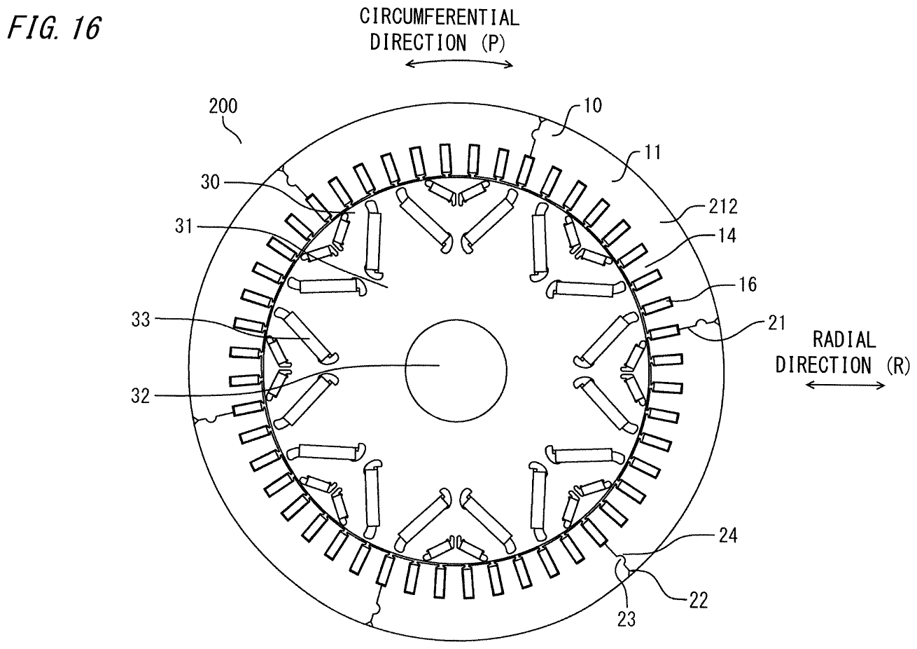

A rotary electric machine of embodiment 2 will be described focusing on a difference from embodiment 1, with reference to FIG. 15 which is a sectional view of a divisional core composing a stator core and FIG. 16 which is a sectional view of a 6-division double-V-shaped interior-magnet-type motor with eight poles and forty-eight slots.

In FIG. 15 and FIG. 16 in embodiment 2, parts that are the same as or correspond to those in embodiment 1 are denoted by the same reference characters.

The rotary electric machine and the divisional core are denoted by 200 and 212, respectively, for the purpose of discrimination from the rotary electric machine 100 and the divisional core 12 of embodiment 1.

As shown in FIG. 15, the divisional core 212 composing the stator core 11 of the rotary electric machine 200 in embodiment 2 is formed by stacking a plurality of electromagnetic steel sheets, and includes a plurality of teeth 14 protruding in the radially inward direction from the arc-shaped core back 13 toward the center axis, and winding slots 15 which are areas between the adjacent teeth 14.

The divisional cores 212 are divided across the core backs 13 from the circumferential-direction centers of the winding slots 15 (core back division). A projection 23 is provided on one side of the abutting parts of the divisional core 212 and a recess 24 is provided on the other side. A groove 22 is provided on an outer circumferential portion. Eight teeth 14 are arranged in the circumferential direction, and the arc angle of the divisional core 212 is 60 degrees.

In FIG. 16, the interior-magnet-type motor which is the rotary electric machine 200 in embodiment 2 is composed of the stator 10, and the rotor 30 which is provided coaxially on the inner circumferential side of the stator 10 and is rotatable relative to the stator 10.

The stator 10 includes the stator core 11, the teeth 14, and the coils 16. The stator core 11 is formed by arranging six divisional cores 212 described with reference to FIG. 15 in an annular shape, and forty-eight teeth 14 are uniformly arranged in the circumferential direction.

Each coil 16 is connected in series to the coil 16 stored in the winding slot 15 that is six-slot away in the circumferential direction. The other configurations are the same as in embodiment 1.

The divisional cores 212 are assembled with their projections 23 and the recesses 24 fitted to each other between the adjacent divisional cores 212, and are fixed by being welded at the grooves 22 on the outer circumferential side of the abutting parts.

In the stator core 11 in embodiment 2, the outer circumferential portions of the abutting parts formed between the divisional cores 212 arranged adjacently to each other are joined with no gap therebetween by welding.

On the other hand, slight gaps 21 are formed on the inner circumferential side of the abutting parts between the divisional cores 212.

In the stator core 11 in embodiment 2, such gaps 21 are formed at most of the abutting parts between the divisional cores 212, depending on manufacturing variations. The widths and the sizes of the gaps 21 are different among the abutting parts between the divisional cores 212.

In particular, in the structure in which outer circumferential portions are joined by welding, the depth to which the joining area by welding reaches in the radial direction varies comparatively greatly. Thus, the width in the radial direction of the slight gap 21 remaining on the inner circumferential side as described above varies comparatively greatly.

By using the divisional cores 212 as described above, the yield of electromagnetic steel sheets improves, so that the material cost can be reduced. Further, by using the divisional cores 212 of which the division number is small, the number of components can be reduced and manufacturing can be facilitated. In addition, the relationship between the number of pole pairs and the division number satisfies P<N<2P (condition A) or 2P<N<4P (condition B), whereby shaft voltage occurring depending on a combination of the number of poles and the division number of the stator core 11 can be reduced. In addition, torque ripple occurring depending on the number of poles and the division number of the stator core 11 can also be suppressed.

Since the divisional cores 212 are assembled using the projections 23 and the recesses 24 at the abutting parts, positioning accuracy of the divisional cores 212 is enhanced, so that manufacturing can be facilitated.

In addition, since the outer circumferential side of the abutting parts between the divisional cores 212 is welded, rigidity of the stator core 11 can be increased.

In addition, since the divisional cores 212 are joined using the groove 22 as a welding groove, a welding bead does not protrude from the outer circumference of the stator core 11, so that irregularities on the outer circumference of the stator core 11 can be eliminated. Then, the stator 10 can be easily attached when being press-fitted into a housing.

In addition, owing to the structure of being divided across the core backs 13 from the circumferential-direction centers of the winding slots 15 (core back division), strain of the teeth 14 is suppressed, whereby manufacturing strain in the entire interior-magnet-type motor is reduced, so that motor loss can be reduced.

In addition, since the circumferential-direction division number N of the stator core 11 is a divisor of the number S of the winding slots 15, all the shapes of the divisional cores 12 composing the stator core 11 can be made the same. Thus, the manufacturing cost for the divisional core 212 can be reduced.

Meanwhile, in embodiment 2, the grooves 22 are present on the outer circumferential portions of the abutting parts of the divisional cores 212, thus causing permeance harmonics, so that shaft voltage occurs. Then, the shapes of the grooves 22 can vary, so that the shaft voltage increases. However, by applying the division number that satisfies P<N<2P (condition A) or 2P<N<4P (condition B) as described in embodiment 1, it is possible to reduce the shaft voltage more effectively.

In addition, although not shown, even in cases of having different combinations of the number of pole pairs and the number of slots, if the relationship between the number of pole pairs and the division number satisfies P<N<2P (condition A) or 2P<N<4P (condition B), the same effects are provided.

In addition, although not shown, even in different rotor structures, if the relationship between the number of pole pairs and the division number satisfies P<N<2P (condition A) or 2P<N<4P (condition B), the same effects are provided.

In a case where the gaps 21 formed at the abutting parts between the adjacent divisional cores 212 described as the structure of the stator core 11 in embodiment 2 are different in widths and sizes, if the division number is set to be small while satisfying P<N<2P (condition A), permeance harmonics occurring due to variations in the gaps 21 can be reduced, whereby shaft voltage can be reduced more effectively.

In embodiment 2, it has been described that the fixation structure between the adjacent divisional cores 212 is a structure reinforced and fixed by welding, as a preferable example.

However, as a fixation structure between the adjacent divisional cores 212, the stator core 11 may be formed with the divisional cores 212 joined in an annular shape by only a fitting structure of the projection 23 and the recess 24, and an annular-shaped frame may be externally fitted to the outer circumference of the stator core 11. In this case, joining by welding can be omitted. In addition, it is also possible to provide an adhesive such as resin between the adjacent divisional cores 212 so as to adhere and fix them to each other.

Also in such fixation structures, in particular, in a case where the gaps 21 are formed at the abutting parts between the adjacent divisional cores 212, and even in a case where the gaps 21 are different in widths and sizes, if the relationship between the number of pole pairs and the division number satisfies P<N<2P (condition A) or 2P<N<4P (condition B), the effects described in embodiment 1 are provided.

As described above, in the rotary electric machine of embodiment 2, a projection and a recess for fitting are provided at the abutting parts of the divisional cores, and a groove is provided on an outer circumferential portion, and the relationship between the number of pole pairs and the division number satisfies P<N<2P (condition A) or 2P<N<4P (condition B).

Thus, with the rotary electric machine of embodiment 2, it is possible to reduce the material cost and facilitate manufacturing, and also to reduce shaft voltage and suppress torque ripple.

### Embodiment 3

In embodiment 3, the stator core is divided in four stages in the axial direction and is rotationally stacked with 30-degree rotation.

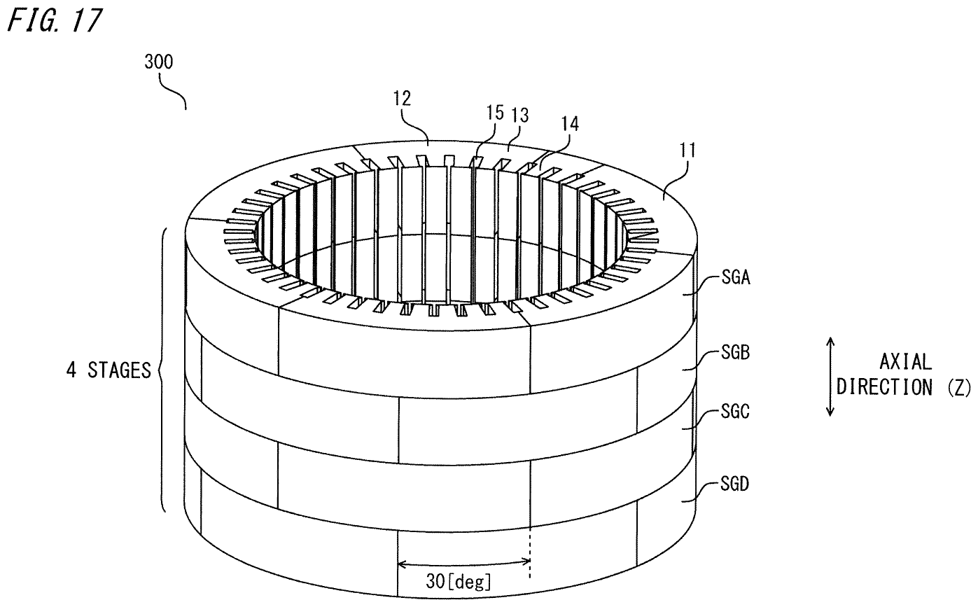

The rotary electric machine of embodiment 3 will be described focusing on a difference from embodiment 1, with reference to FIG. 17 which is a perspective view of a stator core rotationally stacked in four stages with 30-degree rotation.

In FIG. 17 in embodiment 3, parts that are the same as or correspond to those in embodiment 1 are denoted by the same reference characters.

The rotary electric machine is denoted by 300, for the purpose of discrimination from embodiment 1.

The stator core 11 of the rotary electric machine 300 of embodiment 3 is divided into four segments in the axial direction. In FIG. 17, a segment A is shown as SGA, a segment B is shown as SGB, a segment C is shown as SGC, and a segment D is shown as SGD.

The segments A to D are stacked in the axial direction such that, about the rotation axis of the rotor 30, the segment B is rotated by 30 degrees in mechanical angle relative to the segment A, the segment C is rotated by 30 degrees in mechanical angle relative to the segment B, and the segment D is rotated by 30 degrees in mechanical angle relative to the segment C.

Each segment of the stator core 11 is composed of the divisional cores 12 of which the division number is six. The other configurations are the same as those of the rotary electric machine in embodiment 1.

With this configuration, the effects of the rotary electric machine in embodiment 1 are provided, and in addition, rigidity of the stator core 11 formed by a combination of the divisional cores 12 is increased, whereby the vibration resistance and the strength can be improved.

In addition, since the circumferential-direction positions of the winding slots 15 are the same among the segments, the coils 16 can be easily inserted and manufacturing is facilitated.

Further, the influence of magnetic anisotropy in the direction perpendicular to the rolling direction of the teeth 14 of the stator core 11 described later is reduced, whereby motor loss, shaft voltage, and torque ripple in the interior-magnet-type motor can be reduced.

The circumferential-direction division number of the stator core 11 is denoted by N (integer), the axial-direction division number of the stator core 11 is denoted by t (an integer not less than 2), n is defined as an integer, and k is defined as an integer that satisfies k=t/n, to generalize a configuration.

The t segments of the stator core 11 divided in the axial direction are stacked in the axial direction while being rotated by 360/N/k degrees in mechanical angle about the rotation axis of the rotor 30 between the segments adjacent to each other in the axial direction, whereby the same effects as in embodiment 3 are provided.

In addition, a configuration is generalized using the number S of the winding slots 15 of the stator core 11.

The t segments of the stator core 11 divided in the axial direction are stacked in the axial direction while being rotated by (360/S)×n degrees in mechanical angle about the rotation axis of the rotor 30 between the segments adjacent to each other in the axial direction, whereby the same effects as in embodiment 3 are provided.

As in embodiment 2, the divisional cores 12 may be assembled with a projection and a recess provided at abutting parts, whereby positioning accuracy of the divisional cores 12 is enhanced, so that manufacturing can be facilitated. Then, the outer circumferential portions of the abutting parts of the divisional cores 12 may be welded, whereby rigidity of the stator core 11 can be increased. Further, welding may be performed at grooves on the outer circumferential portions of the divisional cores 12, whereby irregularities on the outer circumference of the stator core 11 can be eliminated and the stator 10 can be easily attached when the stator core 11 is inserted into a housing or the like.

As described above, in the rotary electric machine of embodiment 3, the stator core is divided in four stages in the axial direction and is rotationally stacked with 30-degree rotation.

Thus, with the rotary electric machine of embodiment 3, it is possible to reduce the material cost and facilitate manufacturing, and also to reduce shaft voltage and suppress torque ripple. Further, it is possible to increase rigidity of the stator core 11, improve the vibration resistance and the strength, and reduce the influence of magnetic anisotropy in the direction perpendicular to the rolling direction of the teeth 14 of the stator core 11.

### Embodiment 4

In embodiment 4, magnetic anisotropy of the teeth of the stator core is balanced in the entire interior-magnet-type motor.

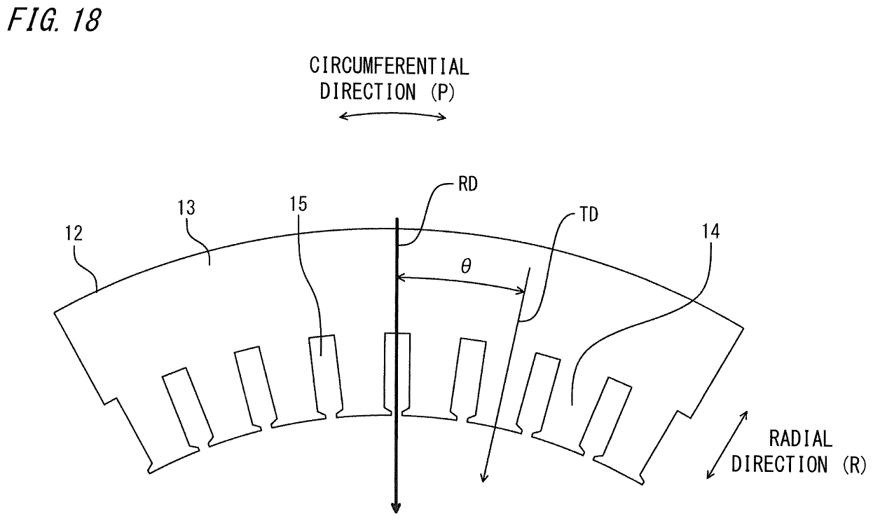

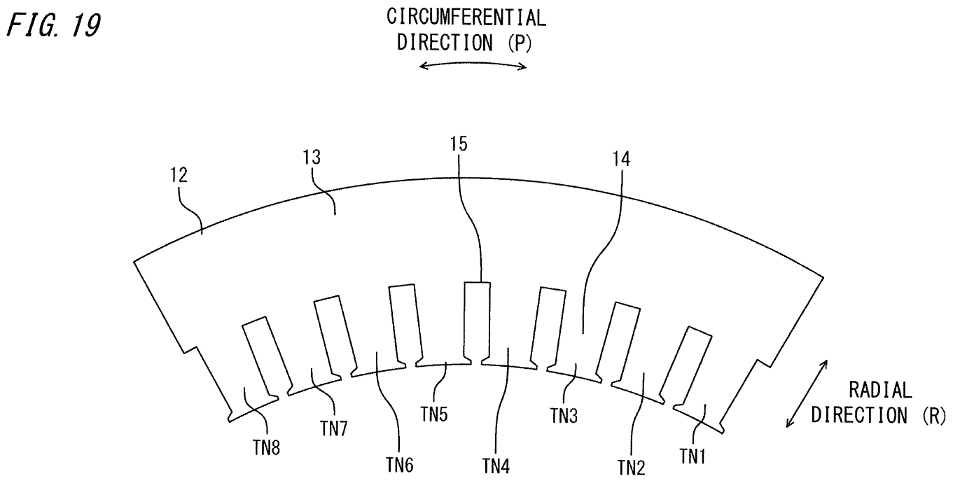

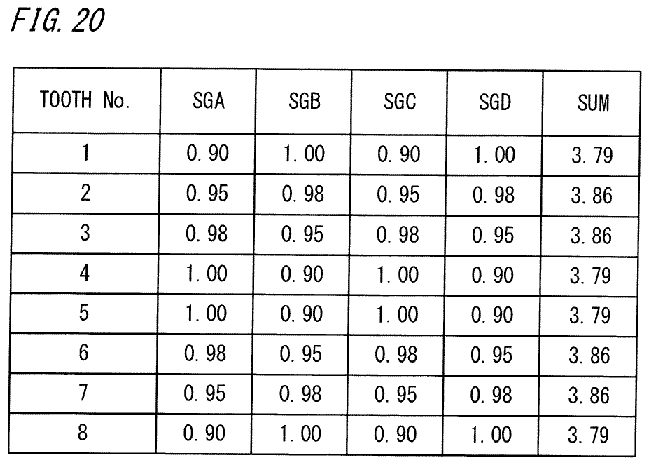

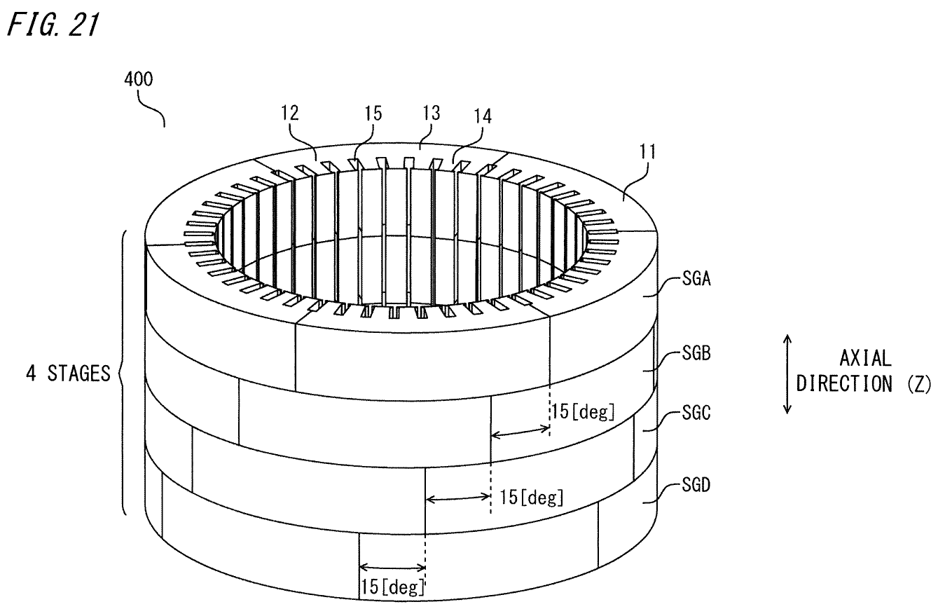

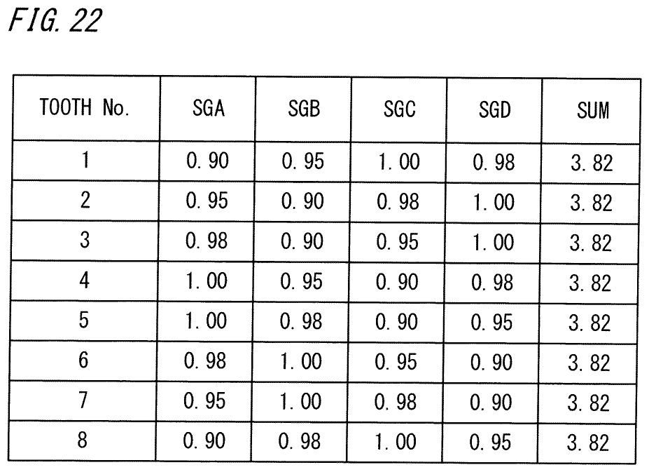

The rotary electric machine of embodiment 4 will be described focusing on a difference from embodiment 1, with reference to FIG. 18 which illustrates a rolling direction and a tooth direction in a sectional view of the divisional core, FIG. 19 which illustrates tooth numbers in a sectional view of the divisional core, FIG. 20 which illustrates tooth-direction components of rolling-direction magnetic characteristics of teeth at the same circumferential-direction position in respective segments of a stator core in a comparative example, FIG. 21 which is a perspective view of a stator core, and FIG. 22 which illustrates tooth-direction components of rolling-direction magnetic characteristics of teeth at the same circumferential-direction position in respective segments of the stator core.

In FIG. 18, FIG. 19, and FIG. 21 in embodiment 4, parts that are the same as or correspond to those in embodiment 1 are denoted by the same reference characters.

The rotary electric machine is denoted by 400, for the purpose of discrimination from the rotary electric machine 100 of embodiment 1.

In FIG. 18, the rolling direction is denoted by “RD”, and the tooth direction is denoted by “TD”. An angle between a rolling-direction vector and a tooth-direction vector is denoted by θ.

An electromagnetic steel sheet composing the divisional core 12 can have magnetic characteristics different between the rolling direction and the direction perpendicular thereto. As shown in FIG. 18, the tooth direction which is a direction in which the tooth 14 faces the rotation center, and the rolling direction, do not coincide with each other, regarding all the teeth 14.

For facilitating the understanding of the following description, tooth numbers are shown in FIG. 19. The teeth of the divisional core 12 are assigned with numbers counterclockwise in the circumferential direction. The tooth numbers 1 to 8 are shown as TN1, TN2, TN3, TN4, TN5, TN6, TN7, and TN8.

Where the angle between the rolling-direction vector and the tooth-direction vector is denoted by θ, a tooth-direction component of a rolling-direction magnetic characteristic of each tooth 14 can be obtained as a cosine of the rolling-direction vector. Then, when the segments of the stator core 11 in four stages in the axial direction are combined, tooth-direction components of rolling-direction magnetic characteristics of the teeth 14 at the same circumferential-direction position are summed.

First, as a comparative example, a case where the stator core 11 of the rotary electric machine 300 in embodiment 3 is divided in four stages and the segments are rotationally stacked with 30 degrees as described in FIG. 17 will be described with reference to FIG. 20.

FIG. 20 shows a result when tooth-direction components of rolling-direction magnetic characteristics of the teeth for the tooth numbers 1 to 8 of the stator core 11 are calculated at the same circumferential-direction position in the segments.

The tooth-direction components of the rolling-direction magnetic characteristics of the teeth 14 at the same circumferential-direction position are summed to be two values, 3.79 and 3.86. Thus, it is found that, in the stator core 11 shown in FIG. 17, the magnetic characteristics of the tooth-direction components are different. Therefore, due to magnetic anisotropy in the direction perpendicular to the rolling direction of the teeth 14 of the stator core 11, increase in motor loss, occurrence of shaft voltage, increase in torque ripple, and the like in the interior-magnet-type motor can be caused.

Accordingly, as shown in FIG. 21, the stator core 11 of the rotary electric machine 400 of embodiment 4 is divided into four segments in the axial direction and each segment is rotated by 15 degrees in mechanical angle. That is, the segments A to D are stacked in the axial direction such that, about the rotation axis of the rotor 30, the segment B is rotated by 15 degrees in mechanical angle relative to the segment A, the segment C is rotated by 15 degrees in mechanical angle relative to the segment B, and the segment D is rotated by 15 degrees in mechanical angle relative to the segment C. Each segment of the stator core 11 is composed of the divisional cores 12 of which the division number is six. The other configurations are the same as in embodiment 1.

FIG. 22 shows a result when tooth-direction components of rolling-direction magnetic characteristics for the tooth numbers 1 to 8 of the stator core 11 of the rotary electric machine 400 in embodiment 4 shown in FIG. 21 are calculated at the same circumferential-direction position in the segments. When the segments of the stator core 11 in four stages are combined, all the sums of the tooth-direction components are 3.82, and thus it is found that they are balanced.

Accordingly, with the configuration of embodiment 4, the effects of the rotary electric machine in embodiment 1 are provided, and in addition, magnetic anisotropy in the direction perpendicular to the rolling direction of all the teeth 14 of the stator core 11 can be balanced in the entire interior-magnet-type motor. Thus, motor loss, shaft voltage, and torque ripple in the interior-magnet-type motor can be reduced.

Further, rigidity of the stator core 11 formed by a combination of the divisional cores 12 is increased, whereby the vibration resistance and the strength can be improved.

In addition, since the circumferential-direction positions of the winding slots 15 are the same among the segments, the coils 16 can be easily inserted and manufacturing is facilitated.

Here, the circumferential-direction division number of the stator core 11 is denoted by N, the axial-direction division number of the stator core 11 is denoted by t, n is defined as an integer, and t is defined as a number that satisfies t=4n, to generalize a configuration.

The t segments of the stator core 11 divided in the axial direction are stacked in t stages in the axial direction while being rotated by 360/N/4 degrees in mechanical angle about the rotation axis of the rotor 30 between the segments adjacent to each other in the axial direction, whereby the same effects are provided.

In addition, as described in embodiment 2, the divisional cores 12 may be assembled with a projection and a recess provided at abutting parts, whereby positioning accuracy of the divisional cores 12 is enhanced, so that manufacturing can be facilitated. Then, the outer circumferential portions of the abutting parts may be welded, whereby rigidity of the stator core 11 can be increased.

Further, welding may be performed at the grooves on the outer circumferential side of the abutting parts of the divisional cores 12, whereby irregularities on the outer circumference of the stator core 11 can be eliminated and the stator 10 can be easily attached when the stator core 11 is inserted into a housing or the like.

As described above, in the rotary electric machine of embodiment 4, magnetic anisotropy of the teeth of the stator core is balanced in the entire interior-magnet-type motor.

Thus, with the rotary electric machine of embodiment 4, it is possible to reduce the material cost and facilitate manufacturing, and also to reduce shaft voltage and suppress torque ripple. Further, it is possible to balance the influence of magnetic anisotropy in the direction perpendicular to the rolling direction of the teeth 14 of the stator core 11, increase rigidity of the stator core 11, and improve the vibration resistance and the strength.

### Embodiment 5

In embodiment 5, tooth division in which the divisional cores are divided at the tooth center is adopted.

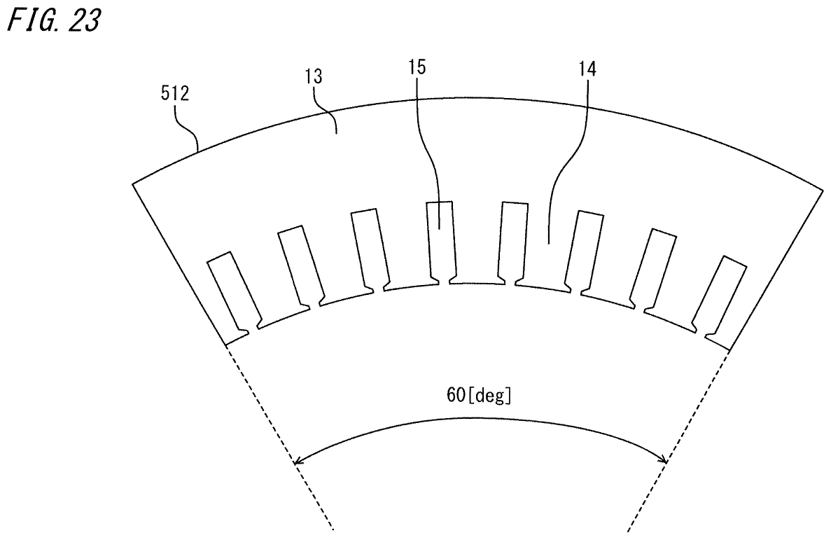

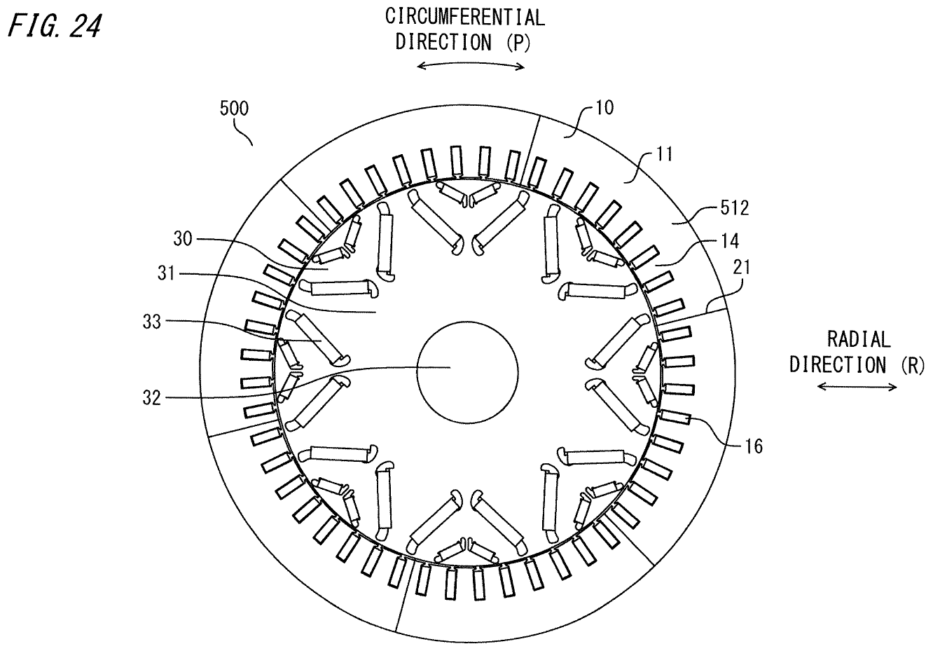

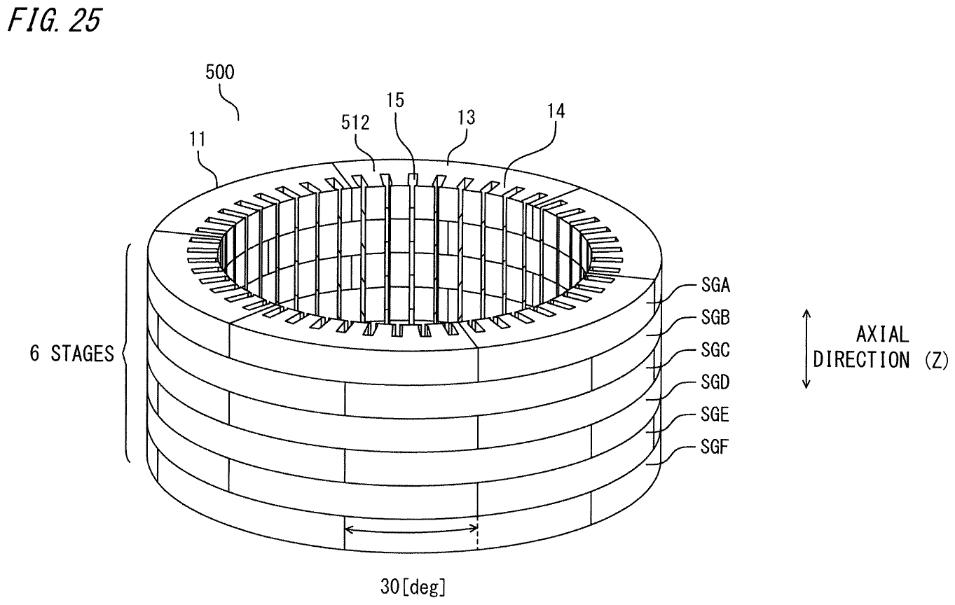

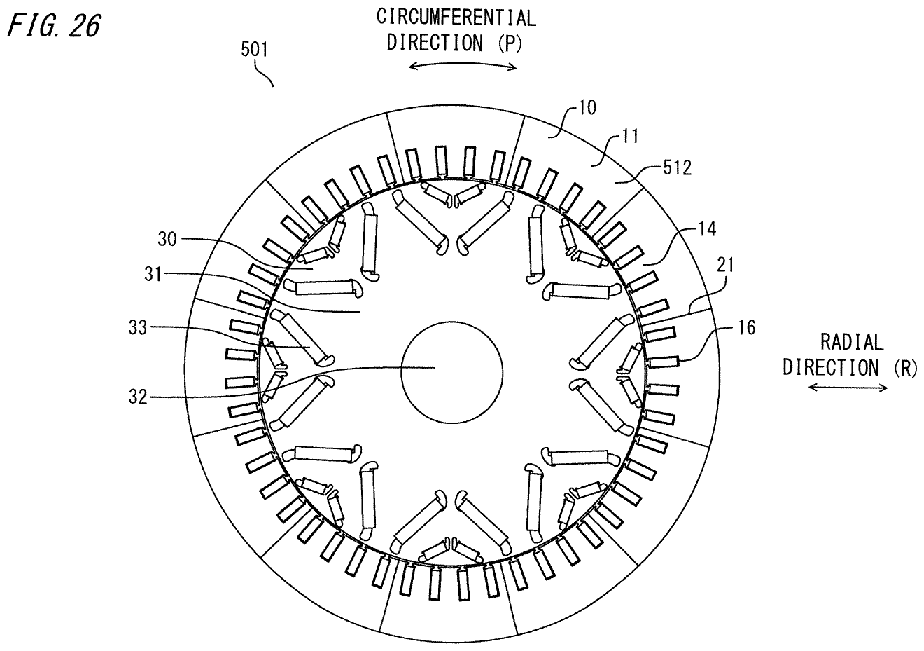

The rotary electric machine of embodiment 5 will be described focusing on a difference from embodiment 1, with reference to FIG. 23 which is a sectional view of the divisional core composing the stator core, FIG. 24 which is a sectional view of a 6-division double-V-shaped interior-magnet-type motor with eight poles and forty-eight slots where the stator core is divided at the tooth center, FIG. 25 which is a perspective view of the stator core rotationally stacked in six stages with 30-degree rotation, and FIG. 26 which is a sectional view of a 12-division double-V-shaped interior-magnet-type motor with eight poles and forty-eight slots where the stator core is divided at the tooth center in a modification.

In FIG. 23 to FIG. 26 in embodiment 5, parts that are the same as or correspond to those in embodiment 1 are denoted by the same reference characters.

The rotary electric machine and the divisional core are denoted by 500 and 512, respectively, for the purpose of discrimination from the rotary electric machine 100 and the divisional core 12 of embodiment 1.

As shown in FIG. 23, the divisional core 512 composing the stator core 11 of the rotary electric machine 500 in embodiment 5 is formed by stacking a plurality of electromagnetic steel sheets, and includes a plurality of teeth 14 protruding in the radially inward direction from the arc-shaped core back 13 toward the center axis, and winding slots 15 which are areas between the adjacent teeth 14. The divisional cores 512 are divided across the core backs 13 from the circumferential-direction centers of the teeth 14 (tooth division).

In each divisional core 512, eight teeth 14 are arranged in the circumferential direction and the arc angle of the divisional core 512 is 60 degrees.

As shown in FIG. 24, in the rotary electric machine 500 in embodiment 5, the stator core 11 is formed by the divisional cores 512 shown in FIG. 23, and the other configurations are the same as in embodiment 1.

As shown in FIG. 25, the stator core 11 is divided into six segments (SGA, SGB, SGC, SGD, SGE, SGF) in the axial direction. The segments of the stator core 11 are stacked in the axial direction while being rotated by 30 degrees in mechanical angle about the rotation axis of the rotor 30 between the segments adjacent to each other in the axial direction. In the drawing, the segment E is shown as SGE and the segment F is shown as SGF.

With this configuration, the yield of electromagnetic steel sheets of the divisional cores 512 improves, so that the material cost can be reduced. Further, by using the divisional cores 512 of which the division number is small, the number of components can be reduced and manufacturing can be facilitated.

In addition, shaft voltage occurring depending on a combination of the number of poles and the division number of the stator core 11 can be reduced. In addition, torque ripple occurring depending on the number of poles and the division number of the stator core 11 can also be suppressed.

In the tooth division, the division position is outside the winding slot 15. Therefore, strain is less likely to occur in the winding slots 15, so that the coils 16 can be easily inserted and manufacturing can be facilitated.

In addition, since the circumferential-direction division number N of the stator core 11 is a divisor of the number S of the winding slots 15, all the shapes of the divisional cores 12 composing the stator core 11 can be made the same. Thus, the manufacturing cost for the divisional core 512 can be reduced.

In FIG. 26, a distributed-winding motor with eight poles and forty-eight slots using twelve divisional cores is shown. Where the number of pole pairs is denoted by P and the circumferential-direction equal-division number of the stator core 11 is denoted by N, if the rotary electric machine satisfies P<N<2P (condition A) or 2P<N<4P (condition B), the same effects as in embodiment 5 are provided. In FIG. 26, the rotary electric machine is denoted by 501, for the purpose of discrimination from the rotary electric machine 500 shown in FIG. 24 and FIG. 25.

In addition, even in cases of having different combinations of the number of pole pairs and the number of slots, if the relationship between the number of pole pairs and the division number satisfies P<N<2P (condition A) or 2P<N<4P (condition B), the same effects are provided.

In addition, even in different rotor structures, if the relationship between the number of pole pairs and the division number satisfies P<N<2P (condition A) or 2P<N<4P (condition B), the same effects are provided.

As in embodiment 2, the divisional cores 512 may be assembled with a projection and a recess provided at abutting parts, whereby positioning accuracy of the divisional cores 12 is enhanced, so that manufacturing can be facilitated.

Then, the outer circumferential portions of the abutting parts of the divisional cores 512 may be welded, whereby rigidity of the stator core 11 can be increased. Further, welding may be performed at grooves on the outer circumferential portions of the divisional cores 512, whereby irregularities on the outer circumference of the stator core 11 can be eliminated and the stator 10 can be easily attached when the stator core 11 is inserted into a housing or the like.

At this time, since the grooves are present on the outer circumferential portions of the abutting parts of the divisional cores 512, permeance harmonics are caused, so that shaft voltage occurs. Then, the shapes of the grooves can vary, so that the shaft voltage increases. However, by applying such a division number that the relationship between the number of pole pairs and the division number satisfies P<N<2P (condition A) or 2P<N<4P (condition B), it is possible to reduce the shaft voltage more effectively.

In a case where the gaps 21 formed at the abutting parts between the adjacent divisional cores 512 described as the configuration of the stator core 11 in embodiment 5 are different in widths and sizes, if the division number is set to be small while satisfying P<N<2P (condition A), permeance harmonics occurring due to variations in the gaps 21 can be reduced, whereby shaft voltage can be reduced more effectively.

Then, by using the rotationally stacked structure with rotation by 30 degrees in mechanical angle, rigidity of the stator core 11 formed by a combination of the divisional cores 512 is increased, whereby the vibration resistance and the strength can be improved. In addition, since the circumferential-direction positions of the winding slots 15 are the same among the segments, the coils 16 can be easily inserted and manufacturing is facilitated. Further, the influence of magnetic anisotropy in the direction perpendicular to the rolling direction of the teeth 14 of the stator core 11 is reduced, whereby motor loss, torque ripple, and shaft voltage in the interior-magnet-type motor can be reduced.

Where the circumferential-direction division number of the stator core 11 is denoted by N, the axial-direction division number of the stator core 11 is denoted by t, n is defined as an integer, and k is defined as a number that satisfies k=t/n, if the t segments of the stator core 11 divided in the axial direction are stacked in t stages in the axial direction while being rotated by 360/N/k degrees in mechanical angle between the segments adjacent to each other in the axial direction, the same effects as in embodiment 3 are provided.

Where t is defined as a number that satisfies t=4n, if the t segments of the stator core 11 divided in the axial direction are stacked in t stages in the axial direction while being rotated by 360/N/4 degrees in mechanical angle between the segments adjacent to each other in the axial direction, the same effects as in embodiment 4 are provided.

As described above, in the rotary electric machine of embodiment 5, tooth division in which the divisional core is divided at the tooth center is adopted.

Thus, with the rotary electric machine of embodiment 5, it is possible to reduce the material cost and facilitate manufacturing, and also to reduce shaft voltage and suppress torque ripple. Further, strain is less likely to occur in the winding slot 15, so that the coil 16 can be easily inserted and manufacturing can be facilitated.

### Embodiment 6

In embodiment 6, core back division is used on one side of the abutting parts of the divisional core, and tooth division is used on the other side.

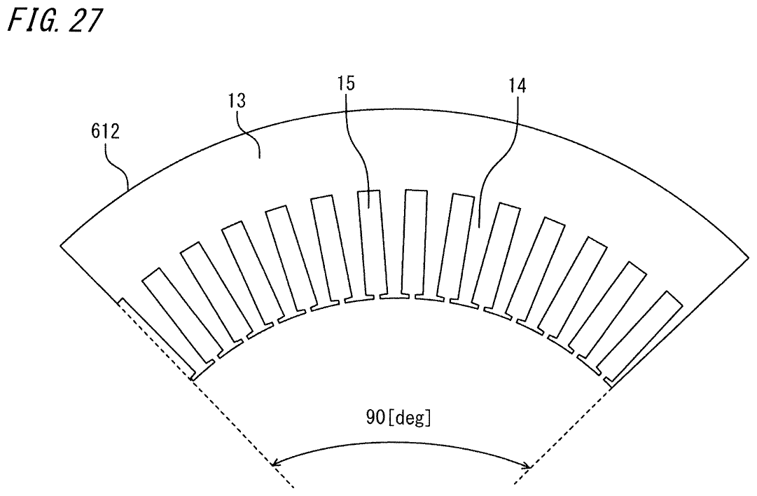

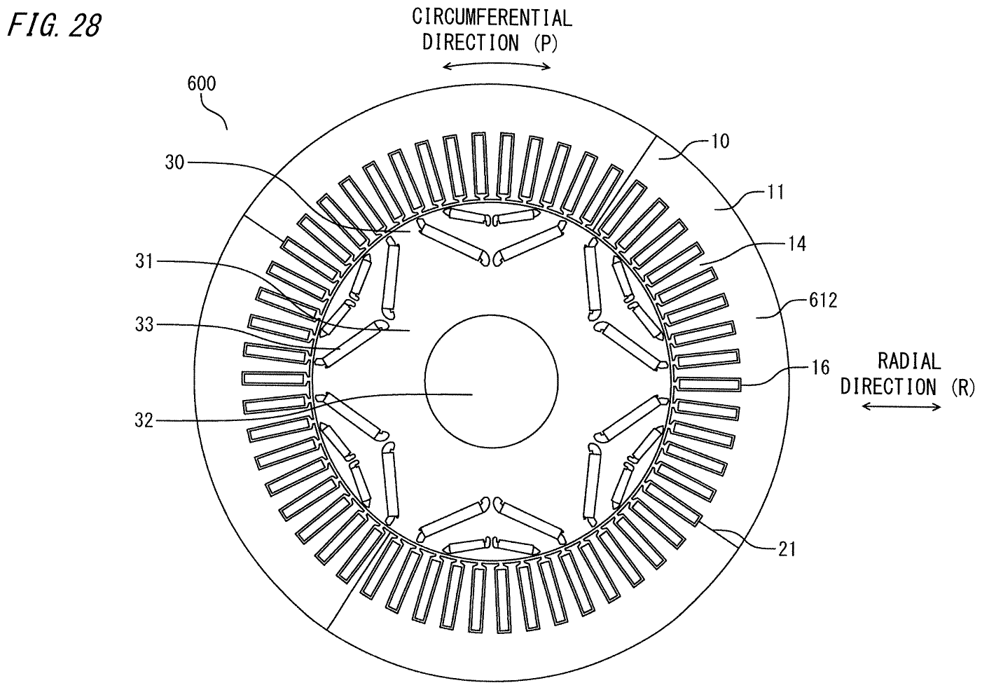

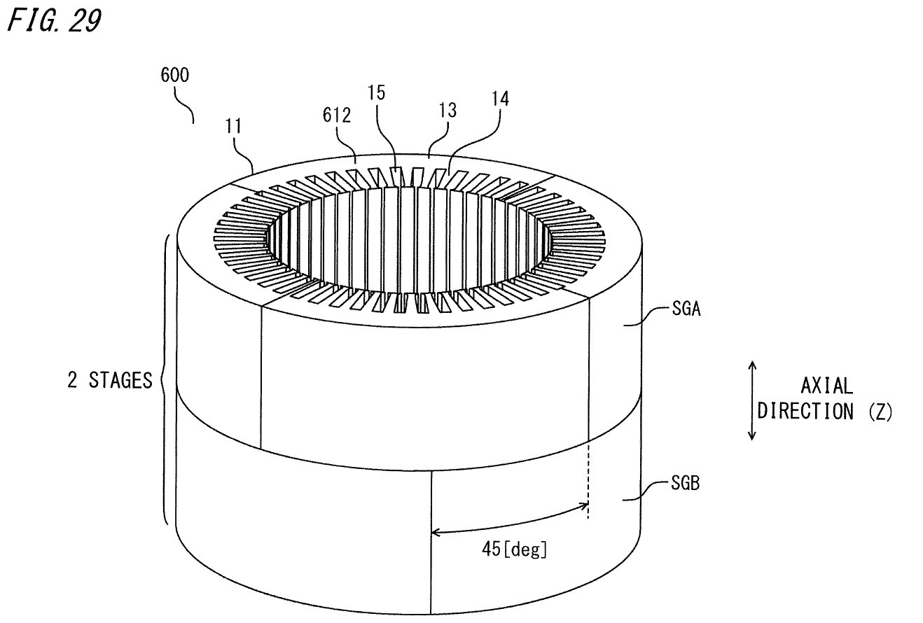

The rotary electric machine of embodiment 6 will be described focusing on a difference from embodiment 1, with reference to FIG. 27 which is a sectional view of the divisional core, FIG. 28 which is a sectional view of a 4-division double-V-shaped interior-magnet-type motor with six poles and fifty-four slots using core back division and tooth division, and FIG. 29 which is a perspective view of a stator core rotationally stacked in two stages with 45-degree rotation.

In FIG. 27 to FIG. 29 in embodiment 6, parts that are the same as or correspond to those in embodiment 1 are denoted by the same reference characters.

The rotary electric machine and the divisional core are denoted by 600 and 612, respectively, for the purpose of discrimination from the rotary electric machine 100 and the divisional core 12 of embodiment 1.

As shown in FIG. 27, the divisional core 612 composing the stator core 11 of the rotary electric machine 600 in embodiment 6 is formed by stacking a plurality of electromagnetic steel sheets, and includes a plurality of teeth 14 protruding in the radially inward direction from the arc-shaped core back 13 toward the center axis, and winding slots 15 which are areas between the adjacent teeth 14. Then, the divisional cores 612 are divided by core back division at the abutting parts on one side and by tooth division at the abutting parts on the other side. The teeth 14 whose number is 13.5 are uniformly arranged in the circumferential direction, and the arc angle of the divisional core 612 is 90 degrees.

As shown in FIG. 28, in the rotary electric machine 600 of embodiment 6, the stator core 11 is formed by the divisional cores 612 shown in FIG. 27, and the other configurations are the same as in embodiment 1.

As shown in FIG. 29, the stator core 11 is divided into two segments in the axial direction, and the segments of the stator core 11 are stacked in two stages in the axial direction while being rotated by 45 degrees in mechanical angle between the segments adjacent to each other in the axial direction. Thus, an interior-magnet-type distributed-winding motor with six poles and fifty-four slots using four divisional cores is formed.

With this configuration, the yield of electromagnetic steel sheets of the divisional cores 612 improves, so that the material cost can be reduced. Further, by using the divisional cores 612 of which the division number is small, the number of components can be reduced and manufacturing can be facilitated. Then, shaft voltage occurring depending on a combination of the number of poles and the division number of the stator core 11 can be reduced. In addition, torque ripple occurring depending on the number of poles and the division number of the stator core 11 can also be suppressed.

Although not shown, also in an interior-magnet-type distributed-winding motor with six poles and fifty-four slots, if the rotary electric machine is configured such that the relationship between the number of pole pairs and the division number satisfies P<N<2P (condition A) or 2P<N<4P (condition B), the same effects as in embodiment 6 are provided. At this time, even if only one of core back division and tooth division is used, the same effects can be obtained.

In addition, even in cases of having different combinations of the number of pole pairs and the number of slots, if the relationship between the number of pole pairs and the division number satisfies P<N<2P (condition A) or 2P<N<4P (condition B), the same effects are provided.

In addition, even in different rotor structures, if the relationship between the number of pole pairs and the division number satisfies P<N<2P (condition A) or 2P<N<4P (condition B), the same effects are provided.

As in embodiment 2, the divisional cores 612 may be assembled with a projection and a recess provided at abutting parts, whereby positioning accuracy of the divisional cores 12 is enhanced, so that manufacturing can be facilitated.

Then, the outer circumferential portions of the abutting parts of the divisional cores 612 may be welded, whereby rigidity of the stator core 11 can be increased. Further, welding may be performed at grooves on the outer circumferential portions of the divisional cores 612, whereby irregularities on the outer circumference of the stator core 11 can be eliminated and the stator 10 can be easily attached when the stator core 11 is inserted into a housing or the like.

At this time, since the grooves are present on the outer circumferential portions of the abutting parts of the divisional cores 612, permeance harmonics are caused, so that shaft voltage occurs. Then, the shapes of the grooves can vary, so that the shaft voltage increases. However, by applying such a division number that the relationship between the number of pole pairs and the division number satisfies P<N<2P (condition A) or 2P<N<4P (condition B), it is possible to reduce the shaft voltage more effectively.

Then, by using the rotationally stacked structure with rotation by 45 degrees in mechanical angle, rigidity of the stator core 11 formed by a combination of the divisional cores 612 is increased, whereby the vibration resistance and the strength can be improved. In addition, since the circumferential-direction positions of the winding slots 15 are the same among the segments, the coils 16 can be easily inserted and manufacturing is facilitated. Further, the influence of magnetic anisotropy in the direction perpendicular to the rolling direction of the teeth 14 of the stator core 11 is reduced, whereby motor loss, torque ripple, and shaft voltage in the interior-magnet-type motor can be reduced.

In a case where the gaps 21 formed at the abutting parts between the adjacent divisional cores 612 described as the configuration of the stator core 11 in embodiment 6 are different in widths and sizes, if the division number is set to be small while satisfying P<N<2P (condition A), permeance harmonics occurring due to variations in the gaps 21 can be reduced, whereby shaft voltage can be reduced more effectively.

Where the circumferential-direction division number of the stator core 11 is denoted by N, the axial-direction division number of the stator core 11 is denoted by t, n is defined as an integer, and k is defined as a number that satisfies k=t/n, if the t segments of the stator core 11 divided in the axial direction are stacked in t stages in the axial direction while being rotated by 360/N/k degrees in mechanical angle about the rotation axis of the rotor 30 between the segments adjacent to each other in the axial direction, the same effects as in embodiment 3 are provided.

Where t is defined as a number that satisfies t=4n, if the t segments of the stator core 11 divided in the axial direction are stacked in t stages in the axial direction while being rotated by 360/N/4 degrees in mechanical angle about the rotation axis of the rotor 30 between the segments adjacent to each other in the axial direction, the same effects as in embodiment 4 are provided.

As described above, in the rotary electric machine of embodiment 6, core back division is used on one side of the abutting parts of the divisional core and tooth division is used on the other side.

Thus, with the rotary electric machine of embodiment 6, it is possible to reduce the material cost and facilitate manufacturing, and also to reduce shaft voltage and suppress torque ripple.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### INDUSTRIAL APPLICABILITY

The rotary electric machine according to the present disclosure makes it possible to provide a rotary electric machine for which the material cost is reduced and manufacturing is facilitated and in which shaft voltage is reduced and torque ripple is suppressed, and therefore is applicable to a wide range of rotary electric machines.

### DESCRIPTION OF THE REFERENCE CHARACTERS

10 stator
11 stator core
12, 212, 512, 612 divisional core
13 core back
14 tooth
15 winding slot
16 coil
21 gap
22 groove
23 projection
24 recess
30 rotor
31 rotor core
32 shaft
33 permanent magnet
34 magnet slot
100, 101, 102, 103, 104, 105, 106, 107, 108, 109, 200, 300, 400, 500, 501, 600 rotary electric machine

1. A rotary electric machine comprising:
a stator including a stator core composed of a plurality of divisional cores divided in a circumferential direction and combined in an annular shape, and a coil wound in a distributed manner on the stator core; and
a rotor including a rotor core fixed to a shaft present at a center axis of the stator, the rotor core being provided with magnetic poles of which a number of pole pairs is P, the rotor being rotatable relative to the stator, wherein
each divisional core has an arc-shaped core back and a plurality of teeth protruding in a radially inward direction from the core back, and has winding slots between the teeth, and the divisional cores have equal numbers of the teeth, and
where a division number of the divisional cores is N, P<N<2P is satisfied.

2. A rotary electric machine comprising:
a stator including a stator core composed of a plurality of divisional cores divided in a circumferential direction and combined in an annular shape, and a coil wound in a distributed manner on the stator core; and
a rotor including a rotor core fixed to a shaft present at a center axis of the stator, the rotor core being provided with magnetic poles of which a number of pole pairs is P, the rotor being rotatable relative to the stator, wherein
each divisional core has an arc-shaped core back and a plurality of teeth protruding in a radially inward direction from the core back, and has winding slots between the teeth, and the divisional cores have equal numbers of the teeth, and
where a division number of the divisional cores is N, 2P<N<4P is satisfied.

3. The rotary electric machine according to claim 1, wherein
there are gaps at abutting parts formed between the divisional cores located adjacently to each other.

4. The rotary electric machine according to claim 3, wherein
widths or sizes of the gaps are different among the abutting parts of the divisional cores.

5. The rotary electric machine according to claim 1, wherein
outer circumferential portions of abutting parts of a plurality of the divisional cores composing the stator core are joined to each other by welding.

6. The rotary electric machine according to claim 1, wherein
the stator core has grooves on outer circumferential portions of abutting parts of a plurality of the divisional cores composing the stator core.

7. The rotary electric machine according to claim 6, wherein the grooves are used as welding grooves.

8. The rotary electric machine according to claim 1, wherein
a projection is provided at an abutting part on one side in the circumferential direction of each divisional core, and a recess is provided at an abutting part on another side in the circumferential direction, and
the stator core has such a structure that the recess and the projection of the abutting parts of the divisional cores are fitted to each other.

9. The rotary electric machine according to claim 1, wherein
where a number of the winding slots of the stator core is an integer S, the circumferential-direction division number N of the stator core is a divisor of S.

10. The rotary electric machine according to claim 1, wherein
the stator core is composed of the divisional cores divided across the core backs from circumferential-direction centers of the winding slots.

11. The rotary electric machine according to claim 1, wherein
the stator core is composed of the divisional cores divided across the core backs from circumferential-direction centers of the teeth.

12. The rotary electric machine according to claim 1, wherein
the stator core is composed of the divisional cores which are, on one side, divided across the core backs from a circumferential-direction center of the winding slot and are, on another side, divided across the core backs from a circumferential-direction center of the tooth.

13. The rotary electric machine according to claim 1, wherein
where a number of winding slots of the stator core is an integer S, t is an integer not less than 2, and n is an integer,
the stator core is formed by stacking t segments in a rotation-axis direction,
each segment is composed of a plurality of the divisional cores divided in the circumferential direction, and
the segments adjacent to each other in the rotation-axis direction are stacked in the rotation-axis direction while being rotated by (360/S)×n degrees in mechanical angle about the rotation axis of the rotor.

14. The rotary electric machine according to claim 1, wherein
where t is an integer not less than 2, n is an integer, and k satisfies k=t/n,
the stator core is formed by stacking t segments in a rotation-axis direction,
each segment is composed of a plurality of the divisional cores divided in the circumferential direction, and
the segments adjacent to each other in the rotation-axis direction are stacked in the rotation-axis direction while being rotated by 360/N/k degrees in mechanical angle about the rotation axis of the rotor.

15. The rotary electric machine according to claim 1, wherein
where t is an integer not less than 2, n is an integer, and t=4n is satisfied,
the stator core is formed by stacking t segments in a rotation-axis direction,
each segment is composed of a plurality of the divisional cores divided in the circumferential direction, and
the segments adjacent to each other in the rotation-axis direction are stacked in the axial direction while being rotated by 360/N/4 degrees in mechanical angle about the rotation axis of the rotor.

16. The rotary electric machine according to claim 1, wherein
the rotor core is an interior-magnet type and has a plurality of magnet slots for insertion and fixation of magnets therein, and a plurality of permanent magnets for forming the magnetic poles.

17. The rotary electric machine according to claim 2, wherein
there are gaps at abutting parts formed between the divisional cores located adjacently to each other.

18. The rotary electric machine according to claim 17, wherein
widths or sizes of the gaps are different among the abutting parts of the divisional cores.

19. The rotary electric machine according to claim 2, wherein
where a number of the winding slots of the stator core is an integer S, the circumferential-direction division number N of the stator core is a divisor of S.

20. The rotary electric machine according to claim 2, wherein
the stator core is composed of the divisional cores divided across the core backs from circumferential-direction centers of the winding slots.
